(19) United States
(12) Patent Application Publication
(10) Pub. No.: US 2026/0163646 A1
(43) Pub. Date: Jun. 11, 2026

(54) DEVICE TOPOLOGIES FOR ELECTRO-PHOTONIC INTEGRATED CIRCUITS COMPRISING TRANSMITTERS AND RECEIVERS

(71) Applicant: ElectroPhotonic-IC Inc., Kanata (CA)

(72) Inventors: Lawrence E. TAROF, Kanata (CA); Jiashu CHEN, Los Altos, CA (US); Derek NAM, Redwood City, CA (US); Yury LOGVIN, Kanata (CA); Vighen PACRADOUNI, Montreal (CA); Francois TREMBLAY, Gatineau (CA)

(21) Appl. No.: 19/408,852

(22) Filed: Dec. 4, 2025

Related U.S. Application Data
(60) Provisional application No. 63/730,667, filed on Dec. 11, 2024.

(51) Int. Cl. H04B 10/43; H04B 10/25; H04B 10/50; H04B 10/61

(52) U.S. Cl. CPC H04B 10/43; H04B 10/2589; H04B 10/5051; H04B 10/615

(57) ABSTRACT

Device topologies for monolithic electro-photonic integrated circuits comprising optical transmitters and receivers are disclosed, wherein each transmitter comprises a first electro-absorption modulator (EAM) waveguide and EAM driver electronics and each receiver comprises a waveguide photodiode, which may be a second EAM waveguide, and a transimpedance amplifier (TIA); and an optical input port for coupling an external laser to each of the transmitters, or an on-chip laser. Monolithic integration of photonics and electronics on a single chip with compact form factor provides reduced interconnect path lengths between the EAMs and the electronics compared to discrete electronics. Tx optical output ports and Rx optical input ports may be interleaved, or banked, along a first (beachfront) edge of the chip with a port-to-port spacing of ≤350 μm. The epitaxial layer structure may be fabricated from InP-based materials providing electronics layers comprising InP HBTs, and overlying photonics layers providing the first and second EAM waveguides.

### CROSS-REFERENCE TO RELATED APPLICATION(S)

This application is a related to U.S. patent application Ser. Nos. 18/962,557 filed Nov. 27, 2024 and 18/743,462, filed Jun. 14, 2024, both entitled “Electro-Photonic Transmitter and Receiver Integrated Circuits (Chiplets) for Co-Packaged Optics and Methods Of Operation”, and PCT International Patent Application no. PCT/CA2024/050804 filed Jun. 14, 2024, all of which claim priority from United States provisional Ser. No. 63/521,411 , filed Jun. 16, 2023, entitled “Indium Phosphide-Based Electro-Photonic Transmitter and Receiver Integrated Circuits (Chiplets) for Co-Packaged Optics and Methods of Operation”, which are incorporated herein by reference in their entirety.

### TECHNICAL FIELD

This invention relates to electro-photonic integrated circuits comprising optical receivers and transmitters, and more particularly relates to Indium Phosphide (InP)-based electro-photonic integrated circuits comprising transmitters and receivers.

### BACKGROUND

For background information, reference is made to a review article entitled “Co-packaged datacenter optics: Opportunities and Challenges”, IET Optoelectronics, 2021; 15: pp. 77-91. For example, FIG. 6 of this reference shows an example roadmap for CPO (Co-Packaged Optics) to illustrate increasing levels of integration of optical modules and switch ASICs (Application Specific Integrated Circuits), using a representation that focuses on linear distance between optical modules and ASICs. Some example distances for Long reach (LR), Medium Reach (MR), Very Short Reach (VSR), Extra Short Reach (XSR), and Ultra Short Reach (USR) are shown in Table 3 of this reference.

Other considerations are cost per capacity ($/Gb/s), energy efficiency (pJ/bit), and reduced port-to-port spacing for high density fiber arrays.

With respect to port-to-port spacing, an important metric for edge-coupled optical devices is edge bandwidth density, e.g. Gbits per mm. The term “beachfront” may be used to refer to the edge dimensions of an electro-photonic integrated circuit, or optical module substrate. Improved edge bandwidth density for edge coupled optical devices, which allows for an increased number of optical fiber I/O connections per unit length, may alternatively be referred to as “reduced beachfront”, increased port density, or reduced edge dimension to accommodate a specific number of optical fiber I/O connections per unit length. Considering a metric which is independent of the bit rate of a digital signal processor, based on an optical port-to-port spacing, the “pitch” typically refers to how many μm for each bi-directional lane, comprising a receiver port and a transmitter port. For example, for an optical port-to-port spacing of 350 μm, which accommodates 250 μm optical fibers, the pitch per bidirectional lane would be 700 μm.

For example, there is a need for improved or alternative electro-photonic integrated circuits comprising receivers and/or transmitters, and solutions for co-packaging of electro-photonic integrated circuits with other electronics for applications such as high-speed data communications.

### SUMMARY OF INVENTION

The present invention seeks to provide improved or alternative electro-photonic integrated circuits comprising receivers and transmitters, monolithic electro-photonic integrated circuits comprising receivers and transmitters, and solutions for co-packaging of electro-photonic integrated circuits with other electronics, e.g. silicon integrated circuits, such as core switch ASICS.

Aspects of the invention provide device topologies for monolithic electro-photonic integrated circuits comprising optical transmitters and receivers, wherein each transmitter comprises a first EAM waveguide and EAM driver electronics and each receiver comprises a waveguide photodiode, which may be a second EAM waveguide, and a transimpedance amplifier (TIA); and either an optical input port for coupling an external laser to each of the transmitters, or an on-chip laser. Monolithic integration of photonics and electronics on a single chip with compact form factor provides reduced interconnect path lengths between the EAMs and the electronics compared to discrete electronics. Tx optical output ports and Rx optical input ports may be interleaved, or banked, along a first (beachfront) edge of the chip with a port-to-port spacing of ≤300 μm. The epitaxial layer structure may be fabricated from III-V semiconductor materials, e.g. InP-based materials providing electronics layers comprising HBTs, and overlying photonics layers providing the first and second EAM waveguides.

One aspect provides a monolithic electro-photonic integrated circuit comprising a transmitter and a receiver, wherein the transmitter comprises an electro-absorption modulator (EAM) and an EAM driver circuit and the receiver comprises a waveguide (WG)-photodiode (PD) and a transimpedance amplifier (TIA), comprising:
a semi-insulating (SI) substrate,
an epitaxial layer stack formed on the SI substrate,
the epitaxial layer stack comprising:
a first plurality of semiconductor layers formed on the SI substrate comprising layers of electronic components comprising heterojunction bipolar transistors of the EAM driver circuit and the TIA;
at least one spacer layer;
a second plurality of semiconductor layers overlying the first plurality of semiconductor layers and the at least one spacer layer, the second plurality of semiconductor layers comprising layers of photonic components comprising a first optical waveguide of the EAM and a second optical waveguide of the WG-PD;
the photonics components comprising the EAM and the WG-PD being formed over a first area and the electronics components comprising the EAM driver circuit and the TIA being formed over a second area [of the integrated circuit]; and
at least one metallization layer providing electrical interconnections between the EAM driver circuit and the EAM and between the WG-PD and the TIA.

In some embodiments, the optical waveguide of the EAM and the optical waveguide of the WG-PIN each comprise Quantum Confined Stark Effect (QCSE) EAM waveguides that are fabricated from the same epitaxial layers of the second plurality of semiconductor layers comprising a p-layer, a Multi-Quantum Well (MQW) i-region and an n-layer.

In some embodiments the optical waveguide of the EAM comprises a Quantum Confined Stark Effect (QCSE) EAM waveguide fabricated from a first set of epitaxial layers of the second plurality of semiconductor layers comprising a p-layer, a Multi-Quantum Well (MQW) i-region and an n-layer; and
the optical waveguide of the WG-PD comprises a Quantum Confined Stark Effect (QCSE) EAM waveguide fabricated from a second set of epitaxial layers of the second plurality of semiconductor layers comprising a p-layer, a Multi-Quantum Well (MQW) i-region and an n-layer; and
a mode separating layer is provided between the first set of epitaxial layers and the second set of epitaxial layers.

The first set of epitaxial layers may overly the second set of epitaxial layers, or the second set of epitaxial layers overlies the first set of epitaxial layers. That is the Tx-EAM may be on top, or the Rx-EAM may be on top.

In some embodiments, the optical waveguide of the EAM comprises a Quantum Confined Stark Effect (QCSE) EAM waveguide fabricated from a first set of epitaxial layers of the second plurality of semiconductor layers comprising a p-layer, a Multi-Quantum Well (MQW) i-region and an n-layer; and
the optical waveguide of the WG-PD is fabricated from a second set of epitaxial layers of the second plurality of semiconductor layers comprising a p-layer, an i-region comprising an absorption material and an n-layer;
and a mode separating layer is provided between the first set of epitaxial layers and the second set of epitaxial layers.

The first set of epitaxial layers overlies the second set of epitaxial layers, or the second set of epitaxial layers overlies the first set of epitaxial layers.

The epitaxial layer structure may comprise a spacer layer comprising at least one layer providing a mode separating layer and/or an electrical isolation layer.

The first plurality of semiconductor layers underlying the photonics components on the first area is laterally electrically isolated from the first plurality of semiconductor layers providing the electronics components on the second area by an electrical isolation region.

In some embodiments, the SI substrate has a first edge of dimension L1 and a second edge of dimension L2 extending perpendicular to the first edge, the first area comprising the photonics components extends from the first edge and optical ports comprising an Rx-input port of the receiver and a Tx-output port are arranged along the first edge, and the second area comprising the electronics components comprises an area behind the first area, extending further from the first edge.

In some embodiments, a laser input port is provided on the first edge for coupling to an external laser, and an optical waveguide connecting the laser input port to an input port of the EAM.

In some embodiments, the monolithic electro-photonic integrated circuit comprises an on-chip laser which is optically coupled to an input port of the EAM to form an electro-absorption modulated laser (EML), a laser waveguide of the laser comprising another set of epitaxial layers of the second plurality of semiconductors layers, and wherein the electronics components comprise a laser driver circuit.

Another aspect provides an electro-photonic module comprising a plurality monolithic integrated circuits as defined in claim 1, and a carrier substrate, the plurality monolithic integrated circuits being arranged with respect to a first edge of the carrier substrate to position optical ports comprising Rx-input ports of the WG-PDs and the Tx-output ports of the EAMs along the first edge.

For example, the Rx-input ports are interleaved with the Tx-output ports along the first edge.

For example, an electro-photonic integrated circuit comprises a transmitter and a receiver, the transmitter comprising an EAM and an EAM Driver having an optical output connected to an optical transmit path and the receiver comprising a PD and a TIA having an optical input connected to an optical receive path, and a semiconductor optical amplifier (SOA) between the optical transmit path and the optical receive path providing a path for implementing direct optical loopback.

Another aspect provides a monolithic electro-photonic integrated circuit comprising a plurality of cells, each cell comprising a transmitter and a receiver, wherein the transmitter comprises an electro-absorption modulator (EAM) and an EAM driver circuit and the receiver comprises a waveguide (WG)-photodiode (PD) and a transimpedance amplifier (TIA), comprising:
a semi-insulating (SI) substrate,
an epitaxial layer stack formed on the SI substrate,
the epitaxial layer stack comprising:
a first plurality of semiconductor layers formed on the SI substrate comprising layers of electronic components comprising heterojunction bipolar transistors of each EAM driver circuit and each TIA;
at least one spacer layer;
a second plurality of semiconductor layers overlying the first plurality of semiconductor layers and the at least one spacer layer, the second plurality of semiconductor layers comprising layers of photonic components comprising a first optical waveguide of each EAM and a second optical waveguide of each WG-PD;
for each cell:
the photonics components comprising the EAM and the WG-PD being formed over a first area of the cell and the electronics components comprising the EAM driver circuit and the
TIA being formed over a second area the cell;
[on-chip] metallization layers providing electrical interconnections between the EAM driver and the EAM and between the WG-PD and the TIA; and
the plurality of cells being arranged with respect to a first edge of the SI substrate to position optical ports comprising Rx-input ports of the WG-PDs and the Tx-output ports of the EAMs along the first edge.

For example, the Rx-input ports are interleaved with the Tx-output ports along the first edge. A port-to-port spacing of the Rx-input ports and the Tx-output ports along the first edge is in a range of 200 μm to 350 μm. A port-to-port spacing of the Rx-input ports and the Tx-output ports along the first edge is <200 μm.

The monolithic integrated circuit may comprise a laser input port on the first edge for receiving an input of an external laser, and an optical waveguide comprising optical splitters connecting the laser input port to input ports of a plurality of the EAMs. For example, a plurality of laser input ports on the first edge, and an optical waveguide comprising optical splitters comprising a 1:N optical splitters connecting each laser input port to input ports of a corresponding plurality N of the EAMs.

In some embodiments the monolithic electro-photonic integrated circuit each cell comprises an on-chip laser which is optically coupled to an input port of the EAM to form an electro-absorption modulated laser (EML), a laser waveguide of the laser comprising another set of epitaxial layers of the second plurality of semiconductors layers, and wherein the electronics components comprise a laser driver circuit.

For example, each electro-photonic integrated circuit comprises
at least one on-chip laser, and optical waveguides comprising an optical splitter for each laser, comprising a 1:N optical splitter, connecting each on-chip laser to input ports of a corresponding plurality N of the EAMs.

In some embodiments, for each cell, the optical waveguide of the EAM and the optical waveguide of the WG-PIN each comprise Quantum Confined Stark Effect (QCSE) EAM waveguides that are fabricated from the same epitaxial layers of the second plurality of semiconductor layers comprising a p-layer, a Multi-Quantum Well (MQW) i-region and an n-layer.

In some embodiments, for each cell, the optical waveguide of the EAM comprises a Quantum Confined Stark Effect (QCSE) EAM waveguide fabricated from a first set of epitaxial layers of the second plurality of semiconductor layers comprising a p-layer, a Multi-Quantum Well (MQW) i-region and an n-layer; and
the optical waveguide of the WG-PD comprises a Quantum Confined Stark Effect (QCSE) EAM waveguide fabricated from a second set of epitaxial layers of the second plurality of semiconductor layers comprising a p-layer, a Multi-Quantum Well (MQW) i-region and an n-layer;
and a mode separating layer is provided between the first set of epitaxial layers and the second set of epitaxial layers.

The Rx-EAM may be on top, or Tx-EAM may be on top

In some embodiments, for each cell, the optical waveguide of the EAM comprises a Quantum Confined Stark Effect (QCSE) EAM waveguide fabricated from a first set of epitaxial layers of the second plurality of semiconductor layers comprising a p-layer, a Multi-Quantum Well (MQW) i-region and an n-layer; and
the optical waveguide of the WG-PD is fabricated from a second set of epitaxial layers of the second plurality of semiconductor layers comprising a p-layer, an i-region comprising an absorption material and an n-layer;
and a mode separating layer is provided between the first set of epitaxial layers and the second set of epitaxial layers.

A spacer layer comprises at least one layer providing a mode separating layer and an electrical isolation layer between the first plurality of semiconductor layers and the overlying second plurality of semiconductor layers.

For each cell, the first plurality of semiconductor layers underlying the photonics components on the first area is laterally electrically isolated from the first plurality of semiconductor layers providing the electronics components on the second area, by an electrical isolation region.

For example, in some embodiments, the SI substrate has a first edge of dimension L1 and a second edge of dimension L2 extending perpendicular to the first edge, the first area comprising the photonics components extends from the first edge and optical ports comprising an Rx-input port of the receiver and a Tx-output port are arranged along the first edge, and the second area comprising the electronics components comprises an area behind the first area, extending further from the first edge.

Yet another aspect provides a monolithic electro-photonic integrated circuit comprising a transmitter and a receiver fabricated on a semi-insulating (SI) substrate, wherein the transmitter comprises an electro-absorption modulator (EAM) and an EAM driver circuit and the receiver comprises a waveguide (WG)-photodiode (PD) and a transimpedance amplifier (TIA);
the SI substrate having a device area defined by a first edge of length L1 and a second edge of length L2, said device area comprising a photonics area and an electronics area;
photonics components comprising the EAM and the WG-PD occupying the photonics area;
electronics components comprising the EAM driver circuit and the TIA occupying the electronics area;
(on-chip) metallization providing electrical connections between the EAM driver circuit and the EAM and between the WG-PD and the TIA;
wherein optical ports comprising an optical input port of the WG-PD and an optical output port of the EAM are arranged along the first edge.

For example, in some embodiments the photonics area is close to the first edge and the electronics area extends behind the photonic area further from the first edge.

In some embodiments, the optical waveguides of the EAM and the WG-PD are arranged side-by-side in the photonics area adjacent the first edge, the optical waveguides of the EAM and the WG-PD being optically coupled to respective optical ports along the first edge, and the electronics area extends behind the photonic area away from the first edge.

In some embodiments, optical waveguides of the EAM and the WG-PD are arranged side-by-side in the photonics area adjacent the first edge, the optical waveguides of the EAM and the WG-PD being optically coupled to respective optical ports along the first edge, and the electronics area comprises an area accommodating the TIA adjacent the WG-PD, and an area accommodating the EAM driver circuit adjacent the EAM.

The electro-photonic integrated circuit may be fabricated with III-V semiconductor materials, for example, an InP-based material system, comprising selected binary, ternary and quaternary and other compositions of In, Ga, As, P, Al, and Sb. In some embodiments, the epitaxial layer structure is compatible with a single epitaxial growth process. For example, the SI substrate is Fe-doped InP.

Thus, device topologies for monolithic electro-photonic integrated circuits comprising receivers and transmitters are disclosed.

### BRIEF DESCRIPTION OF THE DRAWINGS

FIG. 1 is a schematic block diagram of an electro-photonic module comprising an EML of example embodiments configured for bidirectional operation in a transmitter mode and in a receiver mode;

FIG. 2 is a schematic diagram to illustrate bi-directional operation of the electro-photonic module of FIG. 1 in a transmitter mode and in a receiver mode;

FIG. 3 is a schematic top plan view of an electro-photonic module comprising an EML of a first embodiment configured for bidirectional operation as a transmitter and a receiver;

FIG. 4 is a schematic top plan view of a four port electro-photonic module of a second example embodiment comprising four integrated EMLs configured for bidirectional operation as transmitters and receivers;

FIG. 5 is a schematic top plan view of a substrate of a co-packaged optical module comprising an arrangement of 128 optical ports provided by InP electro-photonic chiplets of an example embodiment and a plurality of switch ASICs, to illustrate an example use case;

FIG. 6 is a schematic cross-sectional diagram of an optical transceiver module of example embodiments comprising a substrate, an electro-photonic integrated circuit, a fiber array/attach unit and a switch ASIC;

FIG. 7 is a schematic plan view diagram of an optical transceiver module of example embodiments comprising a substrate, an electro-photonic integrated circuit, a fiber array/attach unit and a switch ASIC;

FIG. 8 is a schematic diagram of a device topology comprising a monolithic electro-photonic integrated circuit of a first embodiment comprising a plurality of transmitters and receivers;

FIG. 9 is a schematic diagram of a device topology comprising an electro-photonic integrated circuit of a second embodiment comprising a plurality of transmitters and receivers;

FIG. 10 is a schematic diagram of a device topology comprising a monolithic electro-photonic integrated circuit of example embodiments comprising a transmitter and a receiver;

FIGS. 11A, 11B and 11C are schematic diagrams of variants of device topologies comprising a monolithic electro-photonic integrated circuit of comprising a transmitter and a receiver;

FIG. 12 is a schematic cross-sectional diagram of an epitaxial layer stack for fabrication of a monolithic electro-photonic integrated circuit of some example embodiments comprising EAM waveguide layers for both Rx and Tx;

FIG. 13 is a schematic isometric view of a device topology of a monolithic electro-photonic integrated circuit of some example embodiments;

FIG. 14 is a schematic cross-sectional diagram of an epitaxial layer stack for fabrication of a monolithic electro-photonic integrated circuit of some example embodiments comprising first and second EAM waveguide layers;

FIG. 15 is a schematic cross-sectional diagram of an epitaxial layer stack for fabrication of a monolithic electro-photonic integrated circuit of some example embodiments comprising first and second EAM waveguide layers;

FIG. 16 is a schematic cross-sectional diagram of a device topology comprising an epitaxial layer stack for fabrication of a monolithic electro-photonic integrated circuit of some example embodiments comprising first and second EAM waveguide layers;

FIG. 17 is a schematic cross-sectional view of the epilayer structure, e.g. as illustrated schematically in FIG. 12 and FIG. 16 to illustrate more details of the epi-layer structure fabricated with an InP-based materials system.

FIG. 18 is a schematic diagram of one cell of a monolithic electro-photonic integrated circuit comprising a transmitter and a receiver having a distributed device topology;

FIG. 19 is a schematic plan view of a device topology of a monolithic electro-photonic integrated circuit of another example embodiment;

FIG. 20 is a schematic plan view of a device topology of a monolithic electro-photonic integrated circuit of another example embodiment;

FIG. 21 is a schematic plan view of a device topology of a monolithic electro-photonic integrated circuit of another example embodiment;

FIG. 22 is a schematic plan view of a device topology of an electro-photonic integrated circuit of another example embodiment;

FIG. 23 is a schematic plan view of a device topology of a monolithic electro-photonic integrated circuit of another example embodiment;

FIG. 24 is a schematic plan view of a device topology of a monolithic electro-photonic integrated circuit of another example embodiment; and

FIG. 25 is a schematic circuit diagram comprising a monolithic electro-photonic integrated circuit comprising a transmitter and a receiver and an optical amplifier to implement a loopback function.

The foregoing and other features, aspects and advantages will be more apparent from the following detailed description, taken in conjunction with the accompanying drawings, of example embodiments, which description is by way of example only.

### DETAILED DESCRIPTION

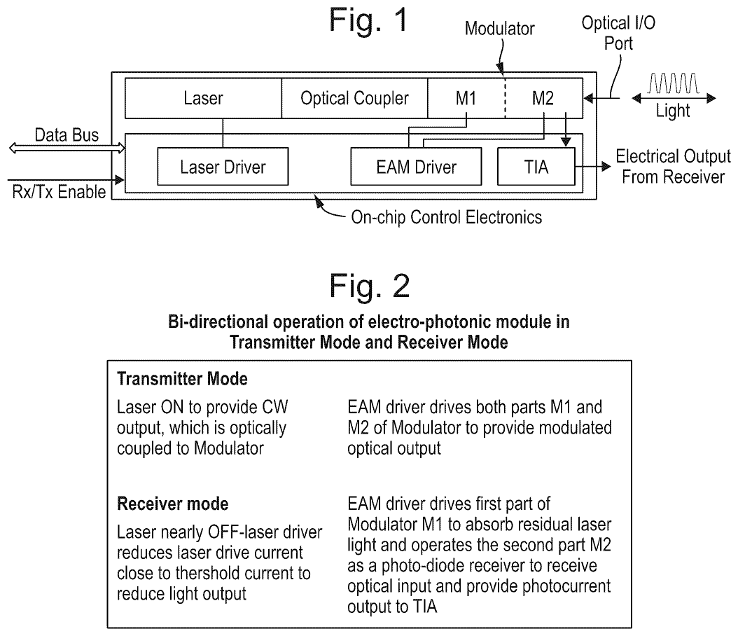

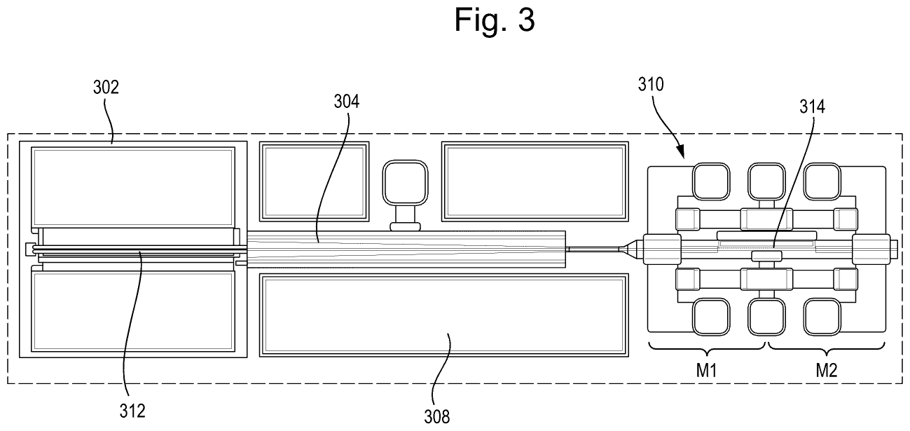

The above-referenced U.S. patent application Ser. No. 18/743,462, filed Jun. 14, 2024, entitled “Electro-Photonic Transmitter and Receiver Integrated Circuits (Chiplets) for Co-Packaged Optics and Methods Of Operation”, discloses an electro-photonic integrated circuit comprising a laser and an electro-absorption modulator (EAM) monolithically integrated with electronic circuitry comprising a laser driver, and EAM driver, and a transimpedance amplifier (TIA). The laser is vertically coupled to the EAM with a laterally tapered vertical optical coupler to form an electro-absorption modulated laser (EML), and the electronic circuitry and electrical contacts are provided on areas adjacent to or surrounding the optical waveguides of the laser, the vertical optical coupler and the EAM, as illustrated schematically in FIG. 1. Operation of the electro-photonic integrated circuit in a transmitter mode and a receiver mode is summarized in FIG. 2. This electro-photonic integrated circuit topology provides for a transceiver module with a very compact layout, as shown schematically in FIG. 3.

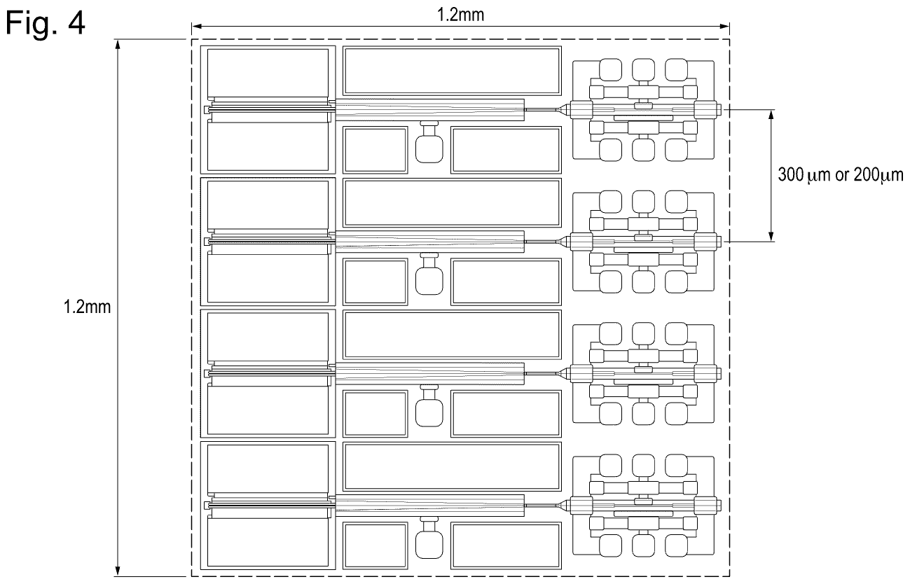

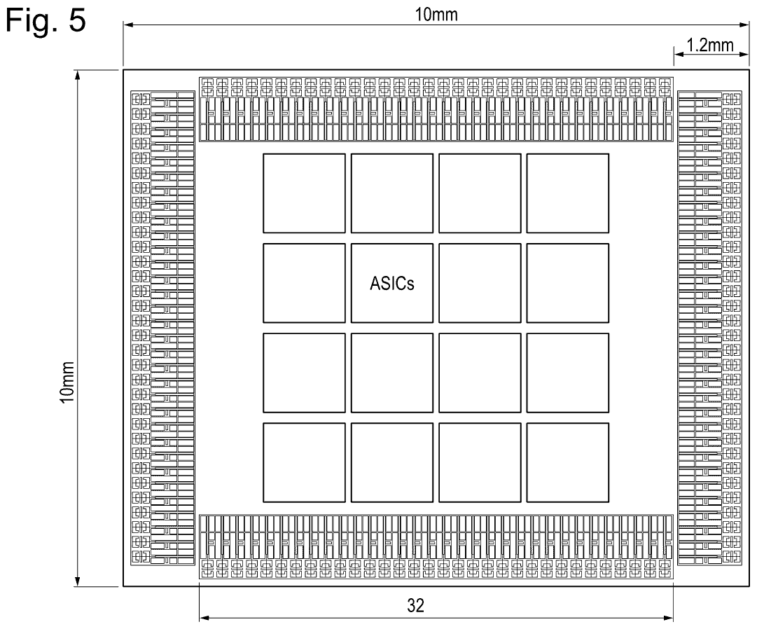

For example, as illustrated schematically in FIG. 4, four electro-photonic ICs, comprising bidirectional EML transceivers, may be arranged on a substrate to provide to provide an optical I/O port-to-port spacing in a range of 200 μm to 300 μm. In an example use case, as illustrated schematically in FIG. 5, a plurality of electro-photonic ICs comprising bidirectional EML transceivers of an example embodiment are arranged around a peripheral area of a substrate to provide 128 optical I/O ports, with an optical I/O port-to-port spacing in a range of 200 μm to 300 μm along each edge of the substrate, and an internal area of the substrate accommodates other electronics such as switch core ASICs. This arrangement provides a high density of optical ports per unit length of the edge dimension of the substrate. On the other hand, since each EML operates bidirectionally in a transmit mode and a receive mode, it is not possible to transmit and receive simultaneously. A bidirectional data bus is required, and the control circuitry comprises a switch, responsive to a transmit enable/receive enable signal, to switch between transmit mode and receive mode.

For applications requiring a monolithic electro-photonic integrated circuit comprising an optical transmitter and an optical receiver, or multiple optical transmitters and optical receivers, that can send and receive simultaneously, devices of alternative embodiments are required. For example, for an arrangement of a four bi-directional EMLs as illustrated schematically in FIG. 4, in an alternative embodiment, the control circuitry comprising the laser driver and the EAM driver, and the TIA circuitry, is configured so that two of the four EML operate only in receiver mode, and the other two of the four EML operate only in transmitter mode. For an arrangement of a plurality of bi-directional EMLs as illustrated in FIG. 5, in an alternative embodiment the control circuitry comprising the laser driver and the EAM driver, and the TIA circuitry, is configured so that some of the EMLs are configured to operate only in receiver mode, and the other EMLs are configured to operate only in transmitter mode. So, this architecture provides for a configurable arrangement of the bi-directional optical chiplets as transmitters and receivers. This mode of operation, with each bi-directional optical chiplet operating in either transmit or receive mode, results in redundancy of electronic and optical components. However, in the event of a device failure, e.g. laser failure in one of the EML chiplets operating in transmit mode, the EML chiplet can be reconfigured to operate in receive mode and one of the other EML chiplets operating in receive mode can be reconfigured to operate in transmit mode.

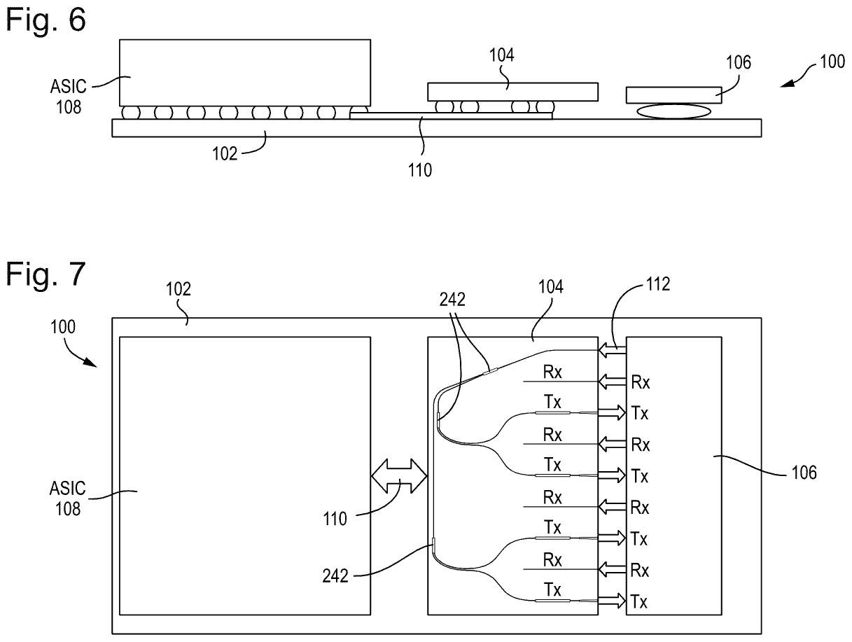

FIG. 6 is a schematic cross-sectional diagram of an optical transceiver module 100 of example embodiments comprising a module substrate 102, and an electro-photonic integrated circuit 104, a fiber array attach unit 106 and a switch ASIC 108 mounted on the substrate 102, with electrical interconnect 110 between the electro-photonic integrated circuit and 104 the switch ASIC 108.

FIG. 7 is a schematic plan view diagram of the optical transceiver module 100, comprising the electro-photonic integrated circuit 104, a fiber array/attach unit 106 and a switch ASIC 108 mounted on the substrate 102, with electrical interconnect 110. The electro-photonic integrated circuit 104 comprises four receiver waveguides, labelled Rx, and four transmitter waveguides, labelled Tx. The fiber array unit provides an array of optical fibers comprising a laser input, four Rx inputs and four Tx outputs. The laser input fiber is optically connected through waveguides and 1×2 optical splitters of the electro-photonic integrated circuit, to provide inputs to each of the four Tx waveguides.

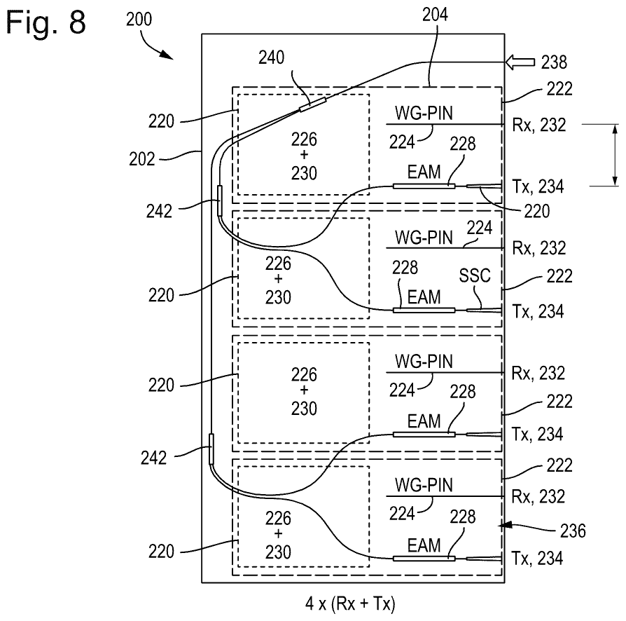

FIG. 8 is a schematic diagram of a device topology comprising a monolithic electro-photonic integrated circuit 200 of a first embodiment comprising a plurality of transmitters 220 and receivers 222, this example comprising four transmitters and four receivers. As illustrated schematically, the electro-photonic integrated circuit 200 comprises a substrate 202 and four cells 204 arranged side-by-side, each cell comprising a receiver 222 and a transmitter 220. Each receiver comprises a waveguide pin photodiode WG-PIN 224 and transimpedance amplifier (TIA) electronics 226. Each transmitter comprises an EAM waveguide 228 and EAM driver electronics 230. The fours cells 204 are monolithically integrated on the substrate 202. In this embodiment, the Rx input ports 232 and Tx output ports 234 are arranged along a first edge 236 of the substrate, with a port-to-port spacing as indicated, and the TIA and EAM driver electronics 226, 230 are positioned behind the optical waveguides 224, 228, spaced further from the first edge of the substrate. An external laser is connected to a laser input port 238, which is coupled through an optical waveguide, e.g. an optical fiber 240 and two 1×2 splitters 242, to provide a cw optical input to each of the EAM waveguides of the transmitters. The four Rx waveguides and the four Tx waveguides arranged in parallel, and interleaved along the first edge of the substrate. This topology is scalable, and larger chip could contain an arrangement of more than four cells, each with a transmitter and receiver, and may comprise an additional laser input to provide optical input to the additional cells. For example, for 250 μm optical fibers, the optical port-to-port spacing is in a range of 300 μm to 350 μm. For smaller diameter optical fibers, e.g. fiber arrays comprising 127 μm diameter optical fibers, the optical port-to-port spacing can be reduced to ˜200 μm, or less.

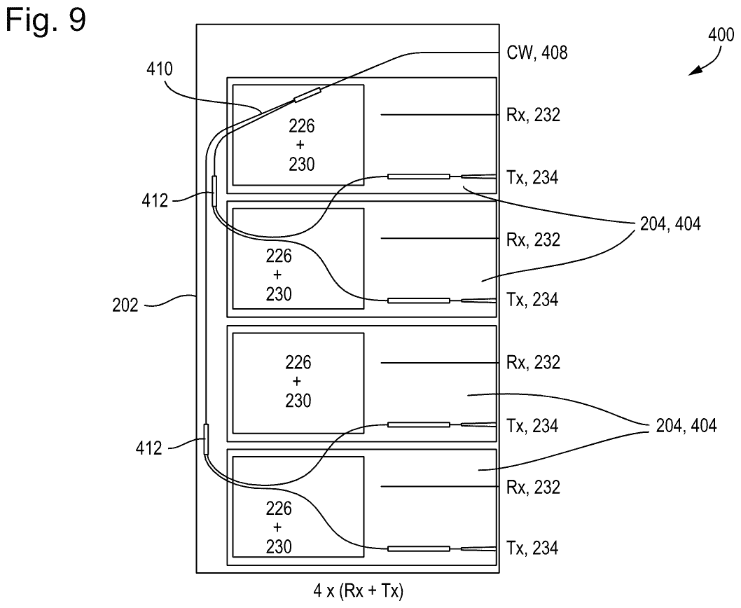

FIG. 9 is a schematic diagram of a device topology comprising an electro-photonic integrated circuit 400 of a second embodiment comprising a plurality of transmitters 402 and receivers 403, wherein each cell 404, 204 is an individual chiplet mounted on a common substrate 406. Each chiplet comprises a monolithic electro-photonic integrated circuit comprising: a receiver comprising a waveguide pin photodiode WG-PIN 224 and TIA electronics 236, and a transmitter comprising an EAM waveguide 228 and driver electronics 230. In this topology, the transmitters 220 and receivers 222 are interleaved. An external laser is connected to a laser input port 408, which is coupled through an optical waveguide, e.g. an optical fiber 410 and two 1×2 splitters 412 to provide a cw optical input to each of the four EAM waveguides of the transmitters.

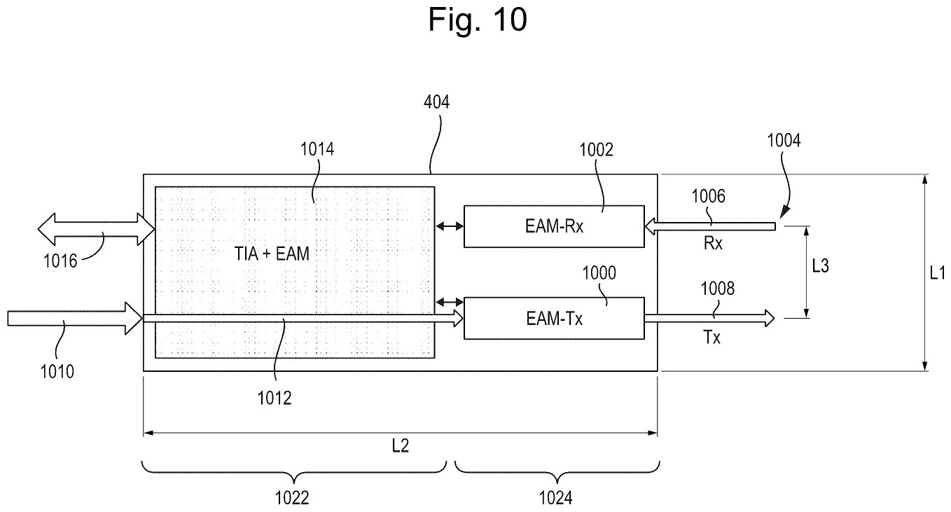

FIG. 10 is an enlarged schematic diagram of one chiplet 404 from FIG. 9, comprising one transmitter 1000 and one receiver 1002 to illustrate the device topology conceptually. The substrate has a rectangular device area having a first edge of length L1 and a second edge of length L2. The first edge dimension L1 1004 may be referred to as the “beachfront” of the chip, and the second dimension L2 extending perpendicular to the first edge may be referred to as the “inland” dimension of the chip. As illustrated schematically there is first waveguide (Rx WG-PD) for the receiver having an Rx optical input, and a second waveguide (Tx EAM waveguide) for the transmitter having a Tx optical output. The Rx input port 1006 and the Tx output port 1008 are spaced along the first edge with an optical port-to-port spacing L3. There is a CW laser input port 1010 coupled by an on chip optical waveguide 1012 to the EAM waveguide. The TIA and EAM driver electronics 1014 occupy an area away from the first edge of the substrate, i.e. an area further inland from the beachfront. There is an electrical interface 1016 for connection of the electronics to the switch ASIC, e.g. as shown schematically, along an edge opposite the first (beachfront) edge. The relative dimensions of the areas of the optical waveguides and areas are electronics are not to scale: the dimensions are for illustrative purposes to represent conceptually that the electronic circuitry of the EAM driver and the TIA occupy an electronics area which is positioned behind the photonics area, relative to the first (beachfront) edge. This layout topology potentially allows for providing a tighter optical port-to-port spacing in the photonics area, while the electronics area can be extended in the inland direction L2.

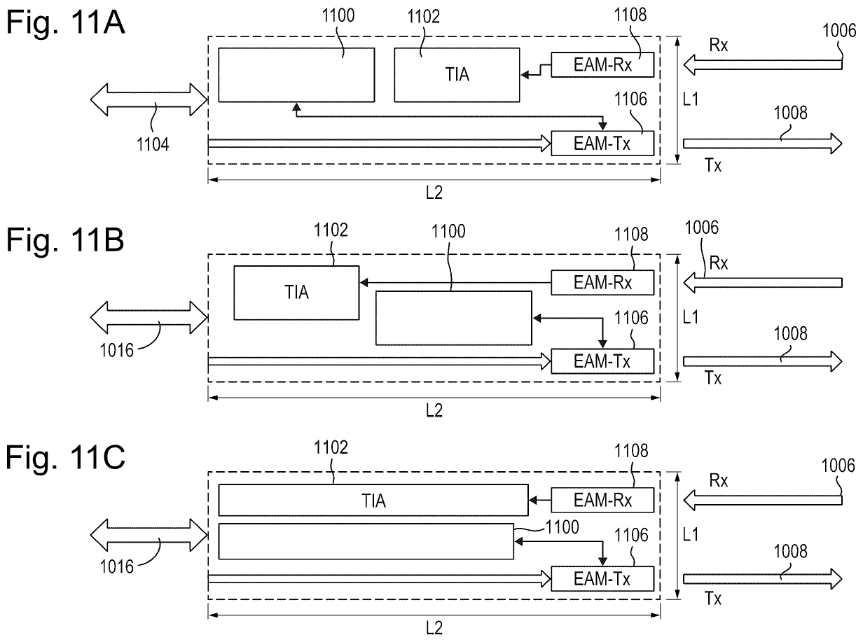

For example, the EAM waveguides for the Tx and Rx may be ˜100 μm long and a few microns wide, and the area of each, as illustrated schematically, includes the contact areas for the EAM waveguides, so each optical waveguide and its contacts is e.g. ˜100 μm long and ˜40 μm wide. For example, the area occupied by the electronics occupies e.g. 10 times the area of the optical waveguides. The port-to-port spacing L3 is determined by the size of the input/output optical fibers, and available fiber array units. For example, to accommodate 250 μm fibers the port-to-port spacing may be in a range of 300 μm to 350 μm. Currently 127 μm fiber array units are commercially available, which would allow the port-to-port spacing L3 to be reduced, e.g. to ≤200 μm. The dimension L1 of the front edge, which accommodates the Rx optical input and the Tx optical output, may be referred to as the pitch. As illustrated schematically, the area available for on-chip electronics extends away from the first edge, along the dimension L2. Combining photonics and electronics monolithically on the same substrate makes this arrangement possible. The driver electronics 1100 or the TIA electronics 1102 could be placed closer to the photonics, or they could be placed equally with respect to the photonics, by changing the area geometry, as shown schematically in FIGS. 11A, 11B and 11C. The electrical interface 1104 for connection to the switch ASIC is on the back edge of the chip, opposite the first (front) edge 1004.

FIG. 11A, FIG. 11B and FIG. 11C show schematic diagrams of device topologies comprising a monolithic electro-photonic integrated circuit comprising a transmitter 1106 and a receiver 1108, to illustrate conceptually how the photonic and electronic components may be arranged. In FIG. 11A, the TIA electronics are placed close to the Rx-EAM, and the driver electronics are placed behind, further from the Tx-EAM. In FIG. 11B, the Driver electronics are placed closed to the Tx-EAM and the TIA electronics are behind, further from the Rx-EAM. In practice, it may be desirable to arrange the electronics as illustrated schematically in FIG. 11C so that the TIA is behind the Rx-EAM to reduce the length of electrical interconnect between the Rx-EAM and the TIA, and the EAM driver electronics are placed behind the Tx-EAM to reduce the length of electrical interconnect between the EAM driver and Tx-EAM. Extending the dimension L2 further inland, and configuring areas for the EAM driver electronics and the TIA electronics to be slim rectangles, to accommodate the area required by the allows for the optical port-to-port spacing for the optical input and output port to be positioned closer together and also provides for short interconnect lengths between the electronics and photonics components.

In example embodiments, monolithic integration of the photonics layers comprising optical waveguides for the Rx EAM and the Tx EAM, and electronics layers for electronics components comprising HBTs is achieved with an epitaxial layer stack fabricated using an InP-based materials system.

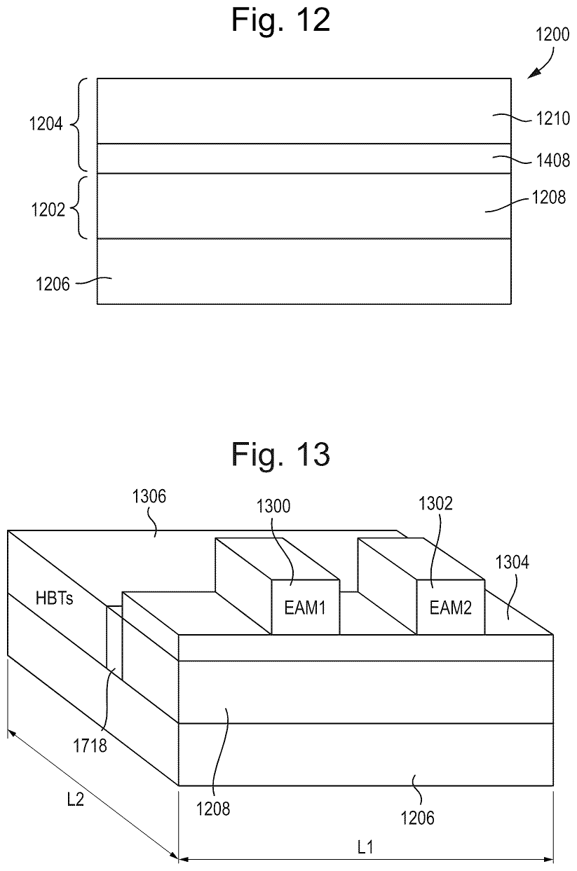

FIG. 12 is a schematic cross-sectional diagram of an epitaxial layer stack 1200 for fabrication of a monolithic electro-photonic integrated circuit of some example embodiments using vertical integration of the electronics 1202 and the photonics 1204 layers. The epitaxial layer stack is fabricated on a semi-insulating (SI) substrate 1206, e.g. a Fe-doped SI InP substrate. A first plurality of semiconductor layers 1208 is structured for fabrication of electronics components comprising InP heterostructure bipolar transistors (HBTs) for the electronics for the TIA and the EAM Driver. A second plurality of semiconductor layers 1210 is structured for fabrication of the EAM waveguides for both the Tx and Rx. One or more spacer layers or mode separating layers 1212 are provided between the first plurality and the second plurality of semiconductor layers.

FIG. 13 is a schematic isometric view of a device topology of a monolithic electro-photonic integrated circuit based on the epitaxial layer structure shown in FIG. 12 of some example embodiments. The EAM waveguide layers are processed to define the Rx-EAM 1 1300 and Tx-EAM 2 1302 on a first area (photonics area) 1304 of the substrate. The photonics layers are removed from a second area (electronics area) 1306 of the substrate and processed to fabricate the electronics components including InP HBTs. If the EAM waveguide is a QCSE (Quantum Confined Stark Effect) waveguide structure in which the i-region comprises a Multi-Quantum Well (MQW) absorption material, the same waveguide structure can be used for both a Tx-EAM waveguide of an EAM and a Rx EAM waveguide of a WG PD. Operation in both Rx and Tx modes is fast. For EAM waveguides, temperature control is provided for both Tx and Rx functions.

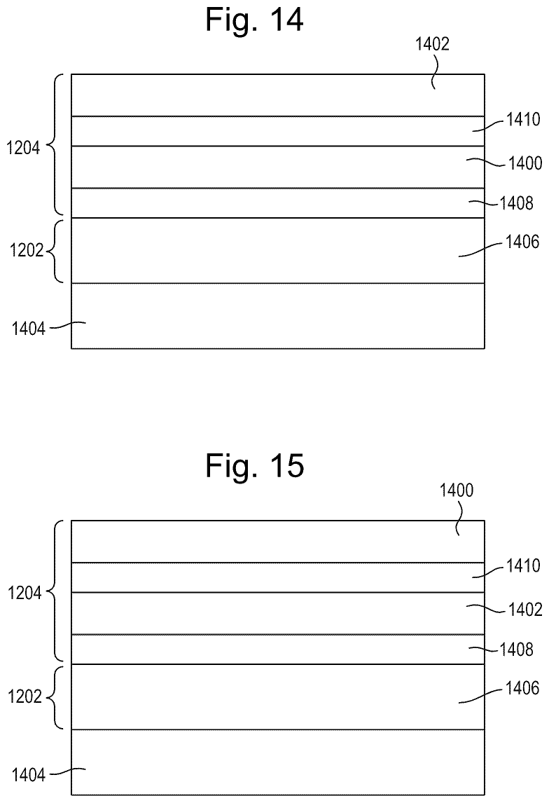

FIG. 14 and FIG. 15 show schematic cross-sectional diagrams of epitaxial layer stacks for fabrication of a monolithic electro-photonic integrated circuit of example embodiments comprising first 1400 and second 1402 EAM waveguide layers. Each epilayer stack comprises a SI InP substrate 1404, a first plurality of semiconductor layers structured for fabrication of the electronics 1406 comprising InP HBTs, a first mode separating layer 1408, a second plurality of semiconductor layers for a first EAM waveguide 1400, a second mode separating layer 1410, and a third plurality of semiconductor layers for a second EAM waveguide 1402. For example, in FIG. 14, the Tx-EAM waveguide layers 1402 are on top with the Rx-EAM waveguide layers 1400 underneath and in FIG. 15 the Rx-EAM waveguide layers 1400 are on top with the Tx-EAM waveguide layers 1402 underneath

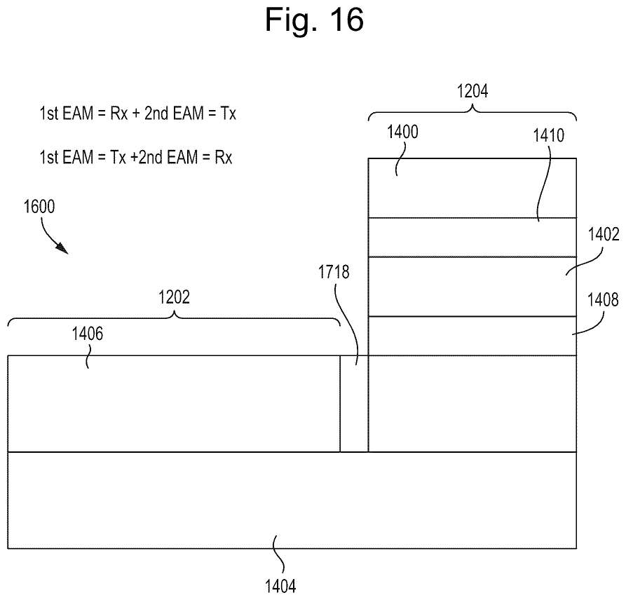

FIG. 16 is a schematic cross-sectional diagram of an epitaxial layer stack for fabrication of a monolithic electro-photonic integrated circuit 1600 of some example embodiments based on the epitaxial layer structures illustrated schematically in FIG. 15 and FIG. 16. In dual EAM waveguide structures, the two EAM waveguides 1400, 1402 can be optimized independently for the Tx and Rx. A Tx EAM waveguide for modulation 448 Gb/s may have a length of ≤60 μm. A Rx EAM waveguide may be ⅓ smaller in length to reduce the device capacitance for matching to capacitance of the TIA electronics. The waveguide widths may be ˜2 μm, and may or may not include a lateral taper.

In each of the epitaxial layer structures, the electronics layers are fabricated on the semi-insulating substrate, and the photonics layers are formed on top of the electronics layers.

In variants of the epitaxial layer structures shown in FIGS. 12 to 16, the epitaxial layer structure for the Tx may comprise additional waveguide structures such as a passive output waveguide, tapered optical coupler, or spot size converter and/or the epitaxial layer structure for the Rx may comprise additional waveguide structures such as a passive input waveguide, tapered optical coupler, or spot size converter.

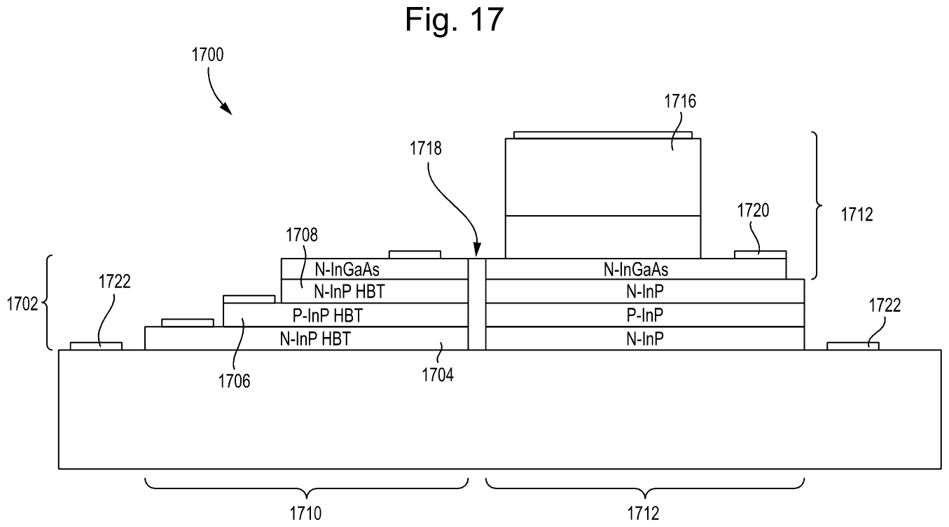

FIG. 17 is a schematic cross-sectional view of an example epilayer structure 1700, e.g. as illustrated schematically in FIG. 12 and FIG. 13, to illustrate more details of the epi-layer structure fabricated with an InP-based materials system. The electronics layers 1702 comprise a layer of N-InP 1704, a layer of P InP 1706 and a layer of N-InP 1708. In the electronics area 1710 for the driver and TIA, the electronics layers are structured to form HBTs of the electronic circuity, with one HBT being shown by way of example. In the photonics area 1712, the photonics layers 1714 are structure to form the Tx-EAM waveguide and the Rx-EAM waveguide, with one EAM waveguide 1716 being shown by way of example. The electronics layers underlying the EAM waveguide are laterally electrically isolated from the HBTs, e.g. by an isolation trench 1718. After processing the photonics structure and the electronics, one or more on-chip metallization layers 1720 are provided to form device contact areas, and to provide electrical interconnections between the Rx-EAM and the TIA, and between the EAM driver and the Rx-EAM, and to provide external contact pads 1722. The electronics components may comprise resistors, capacitors or inductors fabricated with the on-chip metallization layers and intervening dielectric layers.

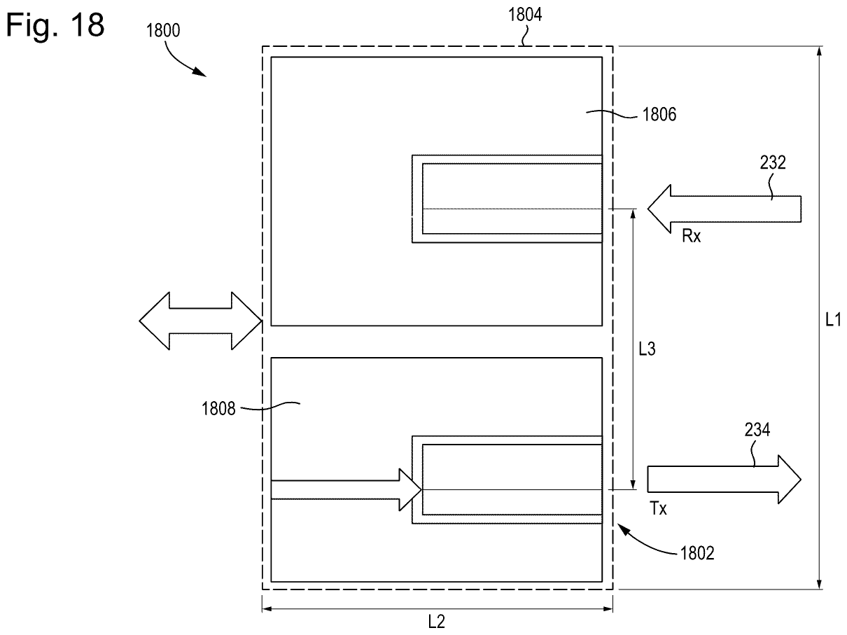

FIG. 18 is a schematic diagram of a device topology for a monolithic electro-photonic integrated circuit 1800 comprising a transmitter 1802 and a receiver 1804 of other embodiments. In practice, the dimensions of the transmitter and receiver waveguides, and their contact areas, occupy a relatively small area of the chip relative to the device areas required for the TIA 1806 and EAM driver 1808 electronics. In device topologies as illustrated schematically in FIG. 18, the photonics area for the Rx and Tx are distributed along the first (beachfront) edge L1, and the electronics areas are distributed around the respective photonics areas. While this topology requires a larger optical port-to-port spacing L3, this topology provides for reduced interconnect distances between the photonics and electronics components for improved electrical performance. For example, if the interconnect distance between the photonics and electronic components is ≤20 μm, interconnect parasitics (interconnect capacitances/inductances/resistances) are reduced, and transmission line effects become negligibly small.

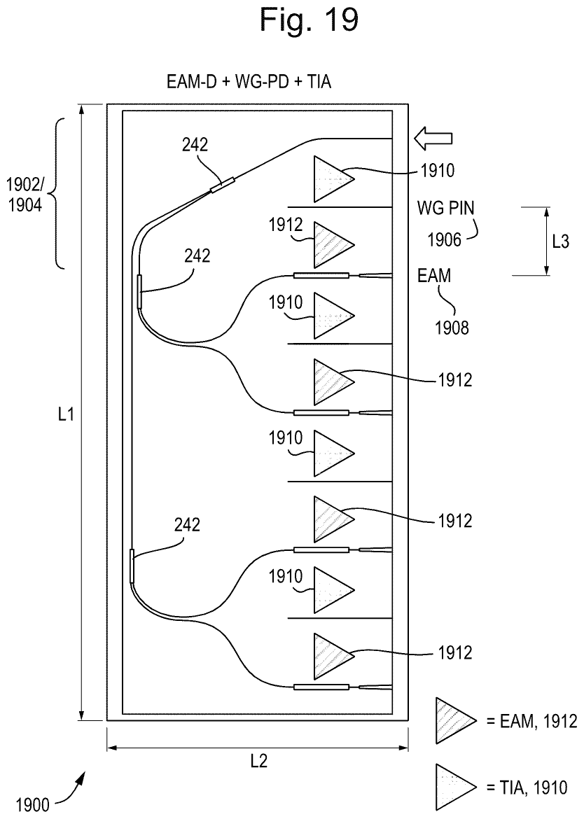

FIG. 19 is a schematic plan view of a monolithic electro-photonic integrated circuit 1900 comprising a device topology of another example embodiment, comprising four transmitters 1902 and four receivers 1904, wherein the Rx/Ms/Rx input ports 1906 and Tx/Ms/Tx output ports 1908 are interleaved along the first edge; each TIA 1910 is located adjacent the corresponding Rx-EAM to reduce the electrical interconnect path between them; and each EAM driver 1912 is located adjacent the corresponding Tx-EAM to reduce the electrical interconnect path between them. Although this topology reduces the electrical interconnection paths, it requires sufficient space between the Rx-EAMs and Tx-EAMs to accommodate the electronics. Nevertheless, if the electronics can be sufficiently miniaturized, it may be feasible to achieve this topology with a port-to-port spacing of 300 μm, or less. For example, as illustrated schematically, an arrangement of 4 Tx and 4 Rx with a port-to-port spacing of 300 μm could be accommodated on a substrate having a beachfront dimension L1 of 2.7 mm. Based on current technology, the port-to-port spacing could feasibly be reduced to 250 μm, or ≤200 μm, to provide a compact form factor.

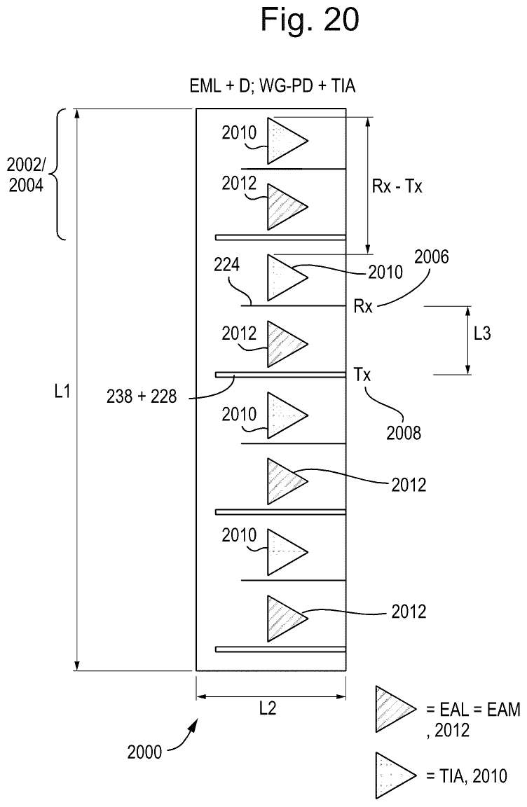

FIG. 20 is a schematic plan view of a monolithic electro-photonic integrated circuit 2000 comprising a device topology of another example embodiment, comprising four transmitters 2002 and four receivers 2004, wherein the Rx/Ms/Rx input ports 2006 and Tx/Ms/Tx output ports 2008 are interleaved along the first edge. Each TIA 2010 is located adjacent the corresponding Rx-EAM to reduce the electrical path between them. Each transmitter comprises an EML 2012 comprising an EAM and integrated laser, and each EML driver comprises a laser driver and EAM driver. Each EML driver is located adjacent the corresponding EML to reduce the electrical interconnect path length between them. The epi-layer structure for the WG-PD and the EML can be tuned to the same wavelength. The laser is integrated into the photonics structure with an additional grating process, e.g. as described in U.S. patent application Ser. no. 17/687,803, entitled “Vertically Integrated Electro-Absorption Modulated Laser”. Although this topology reduces the electrical interconnection paths, it requires sufficient space between the Rx-EAMs and Tx-EMLs to accommodate the electronics. Nevertheless, if the electronics can be sufficiently miniaturized, it may be feasible to achieve this topology with a port-to-port spacing of 300 μm, or less. For example, as illustrated schematically, an arrangement of 4 Tx and 4 Rx with a port-to-port spacing of 300 μm could be accommodated on a substrate having a beachfront dimension L1 of 2.7 mm.

In example embodiments described above, with interleaving of the transmitters and receivers, for each cell comprising an emitter and receiver, reducing the cell size to reduce the port-to-port spacing and pitch for each Tx-Rx pair, potentially creates issues with cross-talk between the transmitters and receivers.

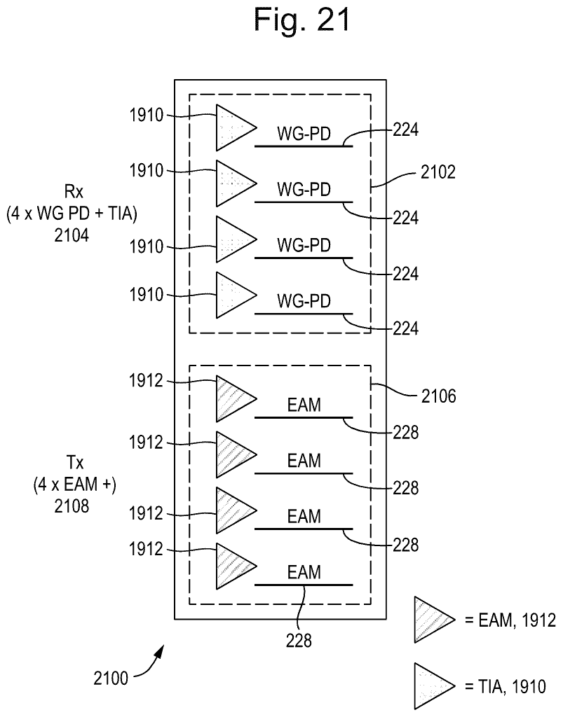

FIG. 21 is a schematic plan view of monolithic electro-photonic integrated circuit 2100 comprising a device topology of another example embodiment in which four receivers 2102 are banked in one cell 2104 and four transmitters 2106 are banked in another cell 2108. This arrangement may be used to reduce cross-talk between the transmitters and receivers.

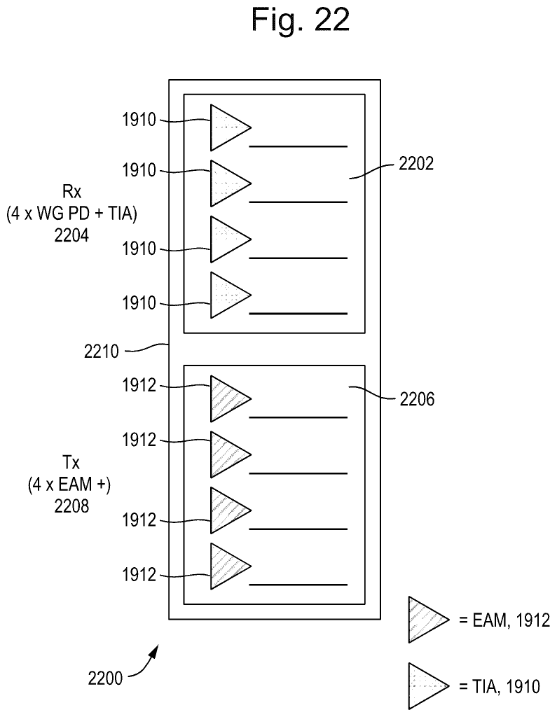

FIG. 22 is a schematic plan view of an electro-photonic integrated circuit module 2200 comprising a device topology of another example embodiment in which four Rx 2202 are banked in one chiplet 2204 and four Tx 2206 are banked in another chiplet 2208, and the two chiplets are mounted on a common substrate or sub-carrier 2210.

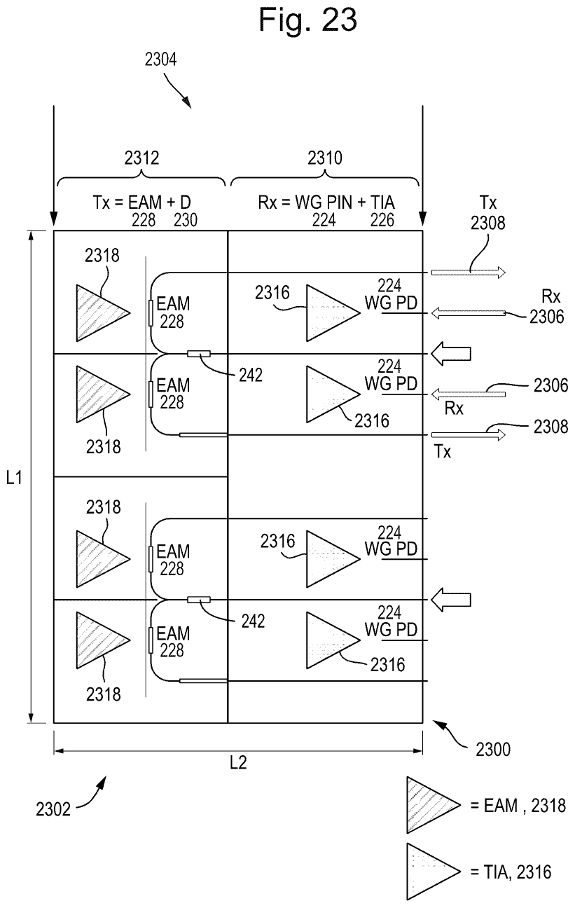

FIG. 23 is a schematic plan view of a monolithic electro-photonic integrated circuit 2300 comprising a device topology of another example embodiment comprising a plurality of transmitters 2302 and receivers 2304, wherein the Rx input ports 2306 and the Tx output ports 2308 are arranged along the first edge of the substrate; the receivers comprising the Rx EAM waveguides (Rx WG-PIN) and the TIA electronics are arranged on a first, forward, area 2310 of the substrate behind the first edge, and the transmitters comprising the Tx EAM waveguides and the driver electronics are arranged on a second, rearward, area 2312 of the substrate further from the first edge. An advantage of this topology is that the TIA electronics are close to the Rx-EAMs/WG-PD to reduce electrical interconnect distances, and the driver electronics are close to the Tx-EAMs to reduce electrical interconnect distances. In this topology, the Rx-EAM waveguides are oriented perpendicular to the first edge. The Tx-EAM waveguides are oriented parallel to the first edge, and a laser input laser1, laser2 is coupled from a laser input port on the first edge, though an on-chip waveguide, e.g. an optical fiber and 1×2 optical splitter to the inputs of two Tx-EAMs, and the output of each Tx-EAM is coupled through another on-chip waveguide, e.g. an optical fiber, to a Tx-output port on the first edge. A laser input is provided to each pair of transmitters. The resulting structure has interleaved I/O ports 2314 in a sequence of: a Tx output port, a Rx input port, a laser input port, a Rx input port and a Tx output. This topology requires additional lengths of optical waveguide for the transmitters, and therefore incurs higher optical losses. On the other hand, the TIA 2316 and EAM driver 2318 electronics are positioned close to their respective waveguides, to reduce interconnect distances, for improved electrical performance.

In a variant of the topology illustrated in FIG. 23, all the transmitters may be provided on one chiplet and all the receivers may be provided on a second chiplet, which are then mounted on a common substrate/sub-carrier.

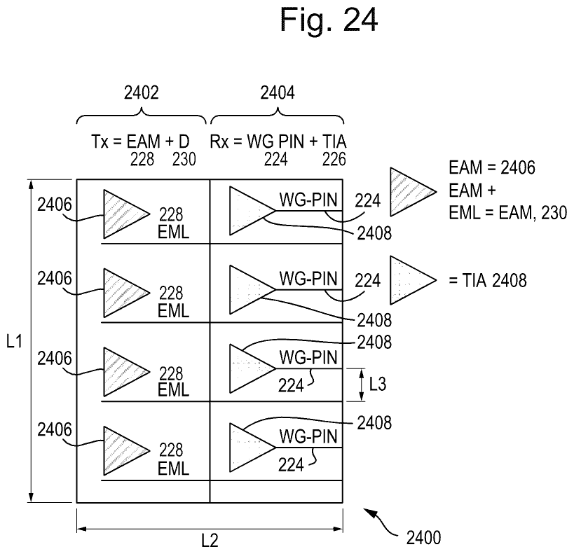

FIG. 24 is a schematic plan view of a monolithic electro-photonic integrated circuit 2400 comprising a device topology of another example embodiment, comprising four transmitters 2402 and four receivers 2404, wherein each transmitter comprises an EML 2406 comprising an on-chip laser and Tx-EAM. The Rx/Ms/Rx input ports and Tx/EAMs/Tx output ports are interleaved along the first edge, and each TIA is located adjacent the corresponding Rx-EAM to reduce the electrical path length between them, and each EAM driver is located adjacent the corresponding laser and Tx-EAM to reduce the electrical path length between them.

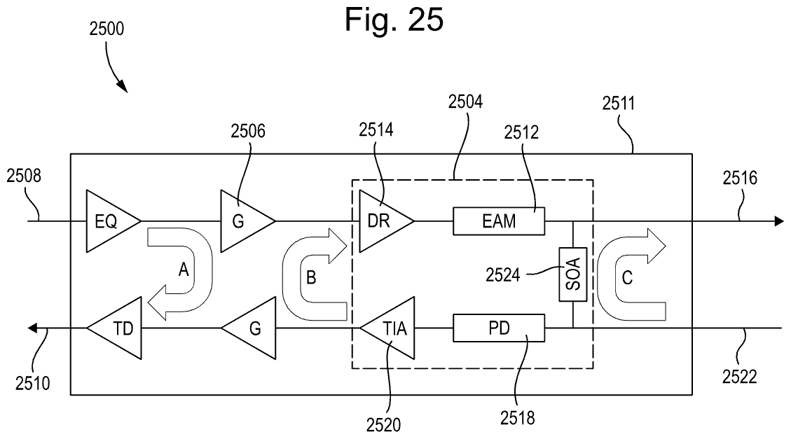

FIG. 25 is a schematic circuit diagram of an electro-optic device 25000 comprising a monolithic electro-photonic integrated circuit 2504 comprising a transmitter and a receiver and an optical amplifier 2506 to implement a loopback function. Loopback functions help to isolate faults and marginal system elements. An electro-photonic integrated circuit comprising a combination a transmitter 2508 and a receiver 2510 on the same substrate 2511 enables loopback functions at various points in the circuit. For example loopback functions can be provided in the electronic domain using electrical paths A or B. For example, a monolithically integrated electro-photonic circuit comprises a transmitter and a receiver, wherein the transmitter comprises an EAM 2512 and an EAM Driver (DR) 2514 and an optical output connect to an optical transmit path 2516, the receiver comprises a PD 2518 and a TIA 2520, an optical input connected to an optical receive path 2522, an integrated semiconductor optical amplifier (SOA) 2524 is provided between the optical transmit path and the optical receive path, as illustrated schematically in FIG. 25, to enable direct optical loopback using optical path C, without electrical conversion.

Monolithic electro-photonic integrated circuits of example embodiments, which provide for monolithic integration of photonic and electronic components optical transmitters and receivers, wherein the transmitter comprises an EAM waveguide and driver circuit and the receiver comprises a WG-PD and TIA. Various device topologies are disclosed which provide one or more benefits and/or trade-offs for electrical performance and optical performance. For example, to reduce the port-to-port spacing for Tx and Rx ports, or to reduce the pitch for a pair of Rx and Tx ports, the photonics components and their Rx and Tx ports are interleaved and arranged along the “beachfront” first edge of the IC substrate, and the electronics components of the EAM driver and TIA are located behind the photonics, spaced further from the first edge, further inland, offering a high port density along the beachfront edge, e.g. ≤300 μm or ≤200 μm port-to-port spacing. For some device topologies the Rx-input ports and the Tx-output ports are interleaved, providing potential compatibility with switch ASICs comprising DSPs configured for an electrical interface with interleaved Rx input and Tx output electricals ports. Where it is desirable to place the TIA electronics in close proximity to the WG-PD, and to place the EAM driver electronics in close proximity to the EAM, to provide interconnect lengths of e.g. ≤20 μm, the port-to-port spacing may be increased to allow the TIA to be positions adjacent the WG-PD and for the EAM driver to be positioned adjacent the EAM. In some embodiments, to reduce cross-talk, the transmitters are banked on one part of the chip and the receivers are banked on another area of the chip. The Tx ports may be banked along a first length of the beachfront edge of the chip, and the Rx ports may be banked along a second length of beachfront edge of the chip. In other embodiments receivers are banked on a forward area of the chip; the transmitters are banked on a rearward area of the chip with additional lengths of waveguides for coupling of an external laser; and the Tx outputs and Rx inputs, and laser inputs are interleaved along the beachfront edge of the chip. In some embodiments, the transmitters are EMLs, each comprising an EAM and integrated laser, laser driver and EAM driver. An external laser input, may be coupled through a 1:N optical splitter to N EAMs, or an internal laser may be coupled through a 1:N optical splitter to N EAMs.

In monolithic electro-photonic integrated circuits of example embodiments, monolithic integration of the electronics and the photonics of the Tx-EAM and driver and the Rx-EAM and TIA is achieved with an epitaxial layer stack fabricated using an InP-based materials system. The electronics layers are fabricated on the semi-insulating SI substrate, e.g. SI InP. The photonics layers are formed overlying the electronics layers, isolated by one or more spacer layers or mode separating layers. After processing the photonics layers to form the EAM waveguides, the photonics layers are removed from the electronics area. The electronics layers that remain under the photonic components are electrically isolated, i.e. the photonics structures are laterally isolated from remaining underlying conductive layers. For example, see FIGS. 11A and 11B of WO2021097560A1 (EML) for an example process for fabrication of a monolithically integrated EML comprising a laser, EAM, laser driver and EAM driver electronics. One or more metallization layers and dielectric layers are provided to complete fabrication of the HBTs, to provide and any other electronic components (capacitors/inductors/resistors) and provide electrical interconnections between the photonics components and electronic components, and external contact pads.

For monolithic electro-photonic integrated circuits of some example embodiments, the epitaxial layer structure is compatible with a single epitaxial growth process, fabricated using III-V semiconductor materials. For example, in some embodiments, the monolithic electro-photonic integrated circuits is fabricated using an InP-based material system, comprising selected binary, ternary and quaternary and other compositions of In, Ga, As, P, Al and Sb. For example, the semi-insulating (SI) substrate may be iron-doped InP. Optionally, fabrication may use multiple epitaxial growths.

The general principles of selecting materials and structuring the waveguide layers for vertical optical coupling using laterally tapered vertical optical couplers, i.e. appropriate selection of bandgap wavelength and refractive index, is described in, e.g. U.S. Pat. No. 7,444,055B2 to Tolstikhin, entitled “Integrated Optics Arrangements for Wavelength (de)Multiplexing in a Multi-Guide Vertical Stack”, and references cited therein.

Fabrication of an electro-photonic integrated circuit comprising a Tx-EAM and monolithically integrated EAM driver circuitry and a Rx-EAM and TIA circuitry, using an InP based material systems and vertical integration, provides for miniaturization and a compact design with a small form factor.

Beneficially, the integrated EAM driver and control circuitry comprises a high-speed electro-optical control loop for very high-speed linearization and temperature compensation, e.g. to enable advanced modulation schemes, such as PAM-4 and DP-QPSK, for analog optical data center interconnect applications.

As described in the parent application U.S. Ser. No. 18/743,462, for transceiver topologies comprising EML where the transmitters comprise an integrated laser, the laser and the EAM forming the EML are optically coupled, e.g. using laterally tapered vertically optical couplers, or a lateral waveguide optical coupler or butt-coupling. A single laser with optical splitters may be used for multiple transmitters. A monolithically integrated laser and EAM can be tuned without heat. For a DFB laser, e.g. having a wavelength temperature sensitivity of 0.09 nm/C and a QCSE EAM with 0.46 nm/C, the bias Vb on the EAM can be varied using a temperature sensor based on the bandgap, to control Vb for temperature compensation, e.g. as disclosed in U.S. Pat. No. 10,673,532, issued Jun. 2, 2020, entitled “Electro-absorption modulator with integrated control loop for linearization and temperature control”.

Structures comprising vertical optical coupling or lateral optical coupling may be fabricated with InP based semiconductor materials, or other semiconductor materials capable of monolithic integration of the photonic components and electronics as described herein.

Although example embodiments have been described and illustrated in detail, it is to be clearly understood that the same is by way of illustration and example only and not to be taken by way of limitation, the scope of the present invention being limited only by the appended claims.

Clauses pertaining to aspects of the invention.

A monolithic electro-photonic integrated circuit comprising a transmitter and a receiver, wherein the transmitter comprises an electro-absorption modulator (EAM) and an EAM driver circuit and the receiver comprises a waveguide (WG)-photodiode (PD) and a transimpedance amplifier (TIA), comprising:
a semi-insulating (SI) substrate,
an epitaxial layer stack formed on the SI substrate,
the epitaxial layer stack comprising:
a first plurality of semiconductor layers formed on the SI substrate comprising layers of electronic components comprising heterojunction bipolar transistors of the EAM driver circuit and the TIA;
at least one spacer layer;
a second plurality of semiconductor layers overlying the first plurality of semiconductor layers and the at least one spacer layer, the second plurality of semiconductor layers comprising layers of photonic components comprising a first optical waveguide of the EAM and a second optical waveguide of the WG-PD;
the photonics components comprising the EAM and the WG-PD being formed over a first device area and the electronics components comprising the EAM driver circuit and the TIA being formed over a second device area;
and
at least one metallization layer providing electrical interconnections between the EAM driver circuit and the EAM and between the WG-PD and the TIA.

The optical waveguide of the EAM and the optical waveguide of the WG-PD each comprise Quantum Confined Stark Effect (QCSE) EAM waveguides that are fabricated from the same epitaxial layers of the second plurality of semiconductor layers comprising a p-layer, a Multi-Quantum Well (MQW) i-region and an n-layer.

The optical waveguide of the EAM comprises a Quantum Confined Stark Effect (QCSE) EAM waveguide fabricated from a first set of epitaxial layers of the second plurality of semiconductor layers comprising a p-layer, a Multi-Quantum Well (MQW) i-region and an n-layer; and
the optical waveguide of the WG-PD comprises a Quantum Confined Stark Effect (QCSE) EAM waveguide fabricated from a second set of epitaxial layers of the second plurality of semiconductor layers comprising a p-layer, a Multi-Quantum Well (MQW) i-region and an n-layer;
and a mode separating layer is provided between the first set of epitaxial layers and the second set of epitaxial layers.

The first set of epitaxial layers overlies the second set of epitaxial layers,
or
the second set of epitaxial layers overlies the first set of epitaxial layers.

The optical waveguide of the EAM comprises a Quantum Confined Stark Effect (QCSE) EAM waveguide fabricated from a first set of epitaxial layers of the second plurality of semiconductor layers comprising a p-layer, a Multi-Quantum Well (MQW) i-region and an n-layer; and
the optical waveguide of the WG-PD is fabricated from a second set of epitaxial layers of the second plurality of semiconductor layers comprising a p-layer, an i-region comprising an absorption material, and an n-layer;
and a mode separating layer is provided between the first set of epitaxial layers and the second set of epitaxial layers.

The first set of epitaxial layers overlies the second set of epitaxial layers,
or
the second set of epitaxial layers overlies the first set of epitaxial layers.

The spacer layer comprises a semi-insulating layer.

The spacer layer comprises at least one layer providing a mode separating layer and an electrical isolation layer
between the first plurality of semiconductor layers and the overlying second plurality of semiconductor layers.

The first plurality of semiconductor layers underlying the photonics components on the first device area is laterally electrically isolated from the first plurality of semiconductor layers providing the electronics components on the second device area by an electrical isolation region.

The SI substrate has a first edge of length L1 and a second edge of length L2 extending perpendicular to the first edge, the first device area comprising the photonics components extends from the first edge and optical ports comprising an Rx-input port of the receiver and a Tx-output port of the transmitter are arranged along the first edge, and the second device area comprising the electronics components is positioned behind the first area, extending further from the first edge.

Comprising a laser input port on a first edge for coupling to an external laser, and an optical waveguide connecting the laser input port to an optical input port of the EAM.

Comprising a laser which is optically coupled to an input port of the EAM to form an electro-absorption modulated laser (EML), a laser waveguide of the laser comprising another set of epitaxial layers of the second plurality of semiconductors layers, wherein the electronics components comprise a laser driver circuit, and the at least one metallization layer provides interconnections between the laser driver circuit and the laser.

An electro-photonic module comprising a plurality monolithic integrated circuits as defined herein, and a carrier substrate, the plurality monolithic integrated circuits being arranged with respect to a first edge of the carrier substrate to position optical ports comprising Rx-input ports of the WG-PDs and the Tx-output ports of the EAMs along the first edge.

The Rx-input ports are interleaved with the Tx-output ports along the first edge.

A monolithic electro-photonic integrated circuit comprising a plurality of cells, each cell comprising a transmitter and a receiver, wherein the transmitter comprises an electro-absorption modulator (EAM) and an EAM driver circuit and the receiver comprises a waveguide (WG)-photodiode (PD) and a transimpedance amplifier (TIA), comprising:
a semi-insulating (SI) substrate,
an epitaxial layer stack formed on the SI substrate,
the epitaxial layer stack comprising:
a first plurality of semiconductor layers formed on the SI substrate comprising layers of electronic components comprising heterojunction bipolar transistors of each EAM driver circuit and each TIA;
at least one spacer layer;
a second plurality of semiconductor layers overlying the first plurality of semiconductor layers and the at least one spacer layer, the second plurality of semiconductor layers comprising layers of photonic components comprising a first optical waveguide of each EAM and a second optical waveguide of each WG-PD;
for each cell:
the photonics components comprising the EAM and the WG-PD being formed on a first device area of the cell and the electronics components comprising the EAM driver circuit and the TIA being formed on a second device area of the cell;
at least one metallization layer providing electrical interconnections between the EAM driver circuit and the EAM and between the WG-PD and the TIA; and
the plurality of cells being arranged with respect to a first edge of the SI substrate to position optical ports comprising Rx-input ports of the WG-PDs and the Tx-output ports of the EAMs along the first edge.

The Rx-input ports and the Tx-output ports are interleaved the first edge.

A port-to-port spacing of the Rx-input ports and the Tx-output ports along the first edge is in a range of 200 μm to 350 μm.

A port-to-port spacing of the Rx-input ports and the Tx-output ports along the first edge is <200 μm.

A laser input port on the first edge for receiving an optical input of an external laser, and an optical waveguide comprising optical splitters connecting the laser input port to input ports of the plurality of the EAMs.

A plurality of laser input ports on the first edge, and an optical waveguide comprising a 1:N optical splitter connecting each laser input port to input ports of a corresponding plurality N of the EAMs.

Each cell comprises a laser which is optically coupled to an input port of the EAM to form an electro-absorption modulated laser (EML), a laser waveguide of the laser comprising another set of epitaxial layers of the second plurality of semiconductors layers, and wherein the electronics components comprise a laser driver circuit, the at least one metallization layer providing an interconnection between the laser driver circuit and the laser.

At least one laser, an optical waveguide comprising a 1:N optical splitter connecting the at least one laser to respective input ports of a corresponding plurality N of the EAMs.

For each cell, the optical waveguide of the EAM and the optical waveguide of the WG-PD each comprise Quantum Confined Stark Effect (QCSE) EAM waveguides that are fabricated from the same epitaxial layers of the second plurality of semiconductor layers comprising a p-layer, a Multi-Quantum Well (MQW) i-region and an n-layer.

For each cell,
the optical waveguide of the EAM comprises a Quantum Confined Stark Effect (QCSE) EAM waveguide fabricated from a first set of epitaxial layers of the second plurality of semiconductor layers comprising a p-layer, a Multi-Quantum Well (MQW) i-region and an n-layer; and
the optical waveguide of the WG-PD comprises a Quantum Confined Stark Effect (QCSE) EAM waveguide fabricated from a second set of epitaxial layers of the second plurality of semiconductor layers comprising a p-layer, a Multi-Quantum Well (MQW) i-region and an n-layer;
and a mode separating layer is provided between the first set of epitaxial layers and the second set of epitaxial layers.

For each cell,
the first set of epitaxial layers overlies the second set of epitaxial layers,
or
the second set of epitaxial layers overlies the first set of epitaxial layers.

For each cell,
the optical waveguide of the EAM comprises a Quantum Confined Stark Effect (QCSE) EAM waveguide fabricated from a first set of epitaxial layers of the second plurality of semiconductor layers comprising a p-layer, a Multi-Quantum Well (MQW) i-region and an n-layer; and
the optical waveguide of the WG-PD is fabricated from a second set of epitaxial layers of the second plurality of semiconductor layers comprising a p-layer, an i-region comprising an absorption material, and an n-layer;
and a mode separating layer is provided between the first set of epitaxial layers and the second set of epitaxial layers.

For each cell:
the first set of epitaxial layers overlies the second set of epitaxial layers,
or
the second set of epitaxial layers overlies the first set of epitaxial layers.

The spacer layer comprises a semi-insulating layer.

The spacer layer comprises at least one layer providing a mode separating layer and an electrical isolation layer between the first plurality of semiconductor layers and the overlying second plurality of semiconductor layers.

For each cell, the first plurality of semiconductor layers underlying the photonics components on the first device area is laterally electrically isolated from the first plurality of semiconductor layers providing the electronics components on the second device area, by an electrical isolation region.

The SI substrate has a first edge of length L1 and a second edge of length L2 extending perpendicular to the first edge,
the plurality of cells being arranged along the first edge to position optical ports comprising Rx-input ports of the WG-PDs and the Tx-output ports of the EAMs along the first edge, the first device area (photonics area) of each cell comprising the photonics components extends from the first edge, and the second device area (electronics area) of each cell comprising the electronics components comprises an area behind the first area, extending further away from the first edge.

The monolithic electro-photonic integrated circuit of claim 15, wherein the photonics area for the receivers and the transmitters comprises a plurality of EAM areas and a plurality of WG-PD areas distributed over the device area, and the electronics area comprises a plurality EAM driver circuit areas and a plurality of TIA areas which are distributed around the plurality of EAM areas and the plurality of WG-PD areas.

Each EAM driver circuit area is adjacent a respective EAM area, and each TIA area is adjacent a respective WG-PD, so that electrical interconnections between each EAM driver circuit and EAM and between each WG-PD and TIA have lengths ≤20 μm.

A monolithic electro-photonic integrated circuit comprising a transmitter and a receiver fabricated on a semi-insulating (SI) substrate, wherein the transmitter comprises an electro-absorption modulator (EAM) and an EAM driver circuit and the receiver comprises a waveguide (WG)-photodiode (PD) and a transimpedance amplifier (TIA);
the SI substrate having a device area defined by a first edge of length L1 and a second edge of length L2, said device area comprising a photonics area and an electronics area;
photonics components comprising the EAM and the WG-PD occupying the photonics area;
electronics components comprising the EAM driver circuit and the TIA occupying the electronics area;
at least one metallization layer providing electrical connections between the EAM driver circuit and the EAM and between the WG-PD and the TIA; and
wherein optical ports comprising an optical input port of the WG-PD and an optical output port of the EAM are arranged along the first edge.
he photonics area is adjacent the first edge and the electronics area extends behind the photonics area further from the first edge.

Optical waveguides of the EAM and the WG-PD are arranged side-by-side in the photonics area adjacent the first edge, the optical waveguides of the EAM and the WG-PD being optically coupled to respective optical ports along the first edge, and the electronics area extends behind the photonic area away from the first edge.

The photonics area comprises an EAM area and a WG-PD area, and the electronics area comprises an EAM driver area distributed around the EAM area and a TIA area distributed around the WG-PD area.

Optical waveguides of the EAM and the WG-PD are arranged side-by-side in the photonics area adjacent the first edge, the optical waveguides of the EAM and the WG-PD being optically coupled to respective optical ports along the first edge, and the electronics area comprises an area adjacent the WG-PD accommodating the TIA, and an area adjacent the EAM accommodating the EAM driver.

The optical ports comprise a laser input port on the first edge and an optical waveguide optically coupling the laser input port to an optical input of the EAM.

The photonics comprises a laser, and an optical waveguide optically coupled to an optical input of the EAM, the laser being provided in the photonics area and the electronics comprising a laser driver circuit in the electronics area, and the at least one metallization layer providing electrical connections between the laser driver circuit and the laser.

A monolithic electro-photonic integrated circuit comprising a plurality of transmitters and a plurality of receivers fabricated on a semi-insulating (SI) substrate, wherein each transmitter comprises an electro-absorption modulator (EAM) and an EAM driver circuit and each receiver comprises a waveguide (WG)-photodiode (PD) and a transimpedance amplifier (TIA);
the SI substrate having a device area defined by a first edge of length L1 and a second edge of length L2, said device area comprising a photonics area and electronics area;
photonics components comprising the EAMs and the WG-PDs occupying the photonics area;
electronics components comprising the EAM driver circuits and the TIAs occupying the electronic area;
at least one metallization layer providing electrical connections between each EAM driver circuit and a respective one of the EAMs and between each WG-PD and a respective one of the TIAs; and
wherein optical ports comprising an optical input port of each WG-PD and an optical output port of each EAM are arranged along the first edge.

The optical output ports and optical input ports are interleaved along the first edge.

The optical output ports are banked, and the optical input ports are banked, along the first edge.

The photonics area extends from the first edge and the electronics area extends behind the photonic area, further from the first edge.

O optical waveguides of the EAMs and the WG-PDs are arranged side-by-side in the photonics area adjacent the first edge, the optical waveguides of the EAMs and the WG-PDs being optically coupled to respective optical ports along the first edge, and the electronics area extends behind the photonics area away from the first edge.

Optical waveguides of the EAMs and the WG-PDs are arranged side-by-side and interleaved in the photonics area adjacent the first edge, the optical waveguides of the EAMs and the WG-PDs being optically coupled to respective optical ports along the first edge, and the electronics area comprises an area adjacent each WG-PD accommodating the respective TIA, and an area adjacent each EAM accommodating the EAM driver.

The optical ports comprise a laser input port on the first edge and an optical waveguide and optical splitters optically coupling the laser input port to optical inputs of the plurality of EAMs.

Each transmitter comprises a laser, the laser being optically coupled to an optical input of the EAM to form an electro-absorption modulated laser, the EML being provided in the photonics area, and the electronics comprising a laser driver circuit in the electronics area, and the at least one metallization layer providing electrical connections between the laser driver circuit and the laser.

The device area comprises a forward area adjacent the first edge, and a rearward area behind the forward area, and
the plurality of transmitters being provided on the rearward area, and the plurality of receivers being provided on the forward area.

The plurality of transmitters is banked on the rearward area with each EAM waveguide oriented parallel to the first edge, and the EAM output being coupled by a waveguide to a respective Tx-output port on the first edge, and each EAM driver circuit being provided adjacent a respective EAM waveguide; and
the plurality of receivers is banked on the forward area with waveguides of each WG-PD oriented perpendicular to the first edge, the WG-PD input being coupled to a respective Rx-input port on the first edge.

Each transmitter comprises a laser, a laser output being coupled to an optical input of the respective EAM.

The Tx optical output ports and the Rx optical input ports are interleaved along the first edge.

A laser input port on the first edge, the laser input port being coupled by an optical waveguide through a 1:N optical splitter to the optical inputs of a corresponding plurality of N EAMs.

4 transmitters and 4 receivers, a first laser input port on the first edge, the first laser input port being coupled by an optical waveguide through a 1:2 optical splitter to the optical inputs of the EAMs of 2 transmitters; a second laser input port on the first edge, the second laser input port being coupled by an optical waveguide through a 1:2 optical splitter to the optical inputs of the EAMs of the other 2 transmitters.

The optical ports are arranged along the first edge in a sequence:
Tx output 1
Rx input 1
Laser 1 input
Rx input 2
Tx output 2
Tx output 3
Rx input 3
Laser 2 input
Rx input 4
Tx output 4.

The monolithic electro-photonic integrated circuit fabricated with III-V semiconductor materials.

The monolithic electro-photonic integrated circuit fabricated with an InP based semiconductor material system.

The monolithic electro-photonic integrated circuit wherein the SI substrate is Fe-doped InP, fabricated from an InP-based material system, comprising selected binary, ternary and quaternary and other compositions of In, Ga, As, P, Al, and Sb.

The monolithic electro-photonic integrated circuit comprising an epilayer structure which is compatible with a single epitaxial growth process.

An electro-photonic integrated circuit comprising a transmitter and a receiver, the transmitter comprising an EAM and an EAM Driver having an optical output connected to an optical transmit path and the receiver comprising a PD and a TIA having an optical input connected to an optical receive path, and a semiconductor optical amplifier (SOA) connected between the optical transmit path and the optical receive path providing a path for implementing direct optical loopback.

1. A monolithic electro-photonic integrated circuit comprising a transmitter and a receiver, wherein the transmitter comprises an electro-absorption modulator (EAM) and an EAM driver circuit and the receiver comprises a waveguide (WG)-photodiode (PD) and a transimpedance amplifier (TIA), comprising:
a semi-insulating (SI) substrate,
an epitaxial layer stack formed on the SI substrate,
the epitaxial layer stack comprising:
a first plurality of semiconductor layers formed on the SI substrate comprising layers of electronic components comprising heterojunction bipolar transistors of the EAM driver circuit and the TIA;
at least one spacer layer;
a second plurality of semiconductor layers overlying the first plurality of semiconductor layers and the at least one spacer layer, the second plurality of semiconductor layers comprising layers of photonic components comprising a first optical waveguide of the EAM and a second optical waveguide of the WG-PD;
the photonics components comprising the EAM and the WG-PD being formed over a first device area and the electronics components comprising the EAM driver circuit and the TIA being formed over a second device area; and
at least one metallization layer providing electrical interconnections between the EAM driver circuit and the EAM and between the WG-PD and the TIA.

2. The monolithic electro-photonic integrated circuit of claim 1, wherein the optical waveguide of the EAM and the optical waveguide of the WG-PD each comprise Quantum Confined Stark Effect (QCSE) EAM waveguides that are fabricated from the same epitaxial layers of the second plurality of semiconductor layers comprising a p-layer, a Multi-Quantum Well (MQW) i-region and an n-layer.

3. The monolithic electro-photonic integrated circuit of claim 1, wherein
the optical waveguide of the EAM comprises a Quantum Confined Stark Effect (QCSE) EAM waveguide fabricated from a first set of epitaxial layers of the second plurality of semiconductor layers comprising a p-layer, a Multi-Quantum Well (MQW) i-region and an n-layer; and
the optical waveguide of the WG-PD comprises a Quantum Confined Stark Effect (QCSE) EAM waveguide fabricated from a second set of epitaxial layers of the second plurality of semiconductor layers comprising a p-layer, a Multi-Quantum Well (MQW) i-region and an n-layer;
and a mode separating layer is provided between the first set of epitaxial layers and the second set of epitaxial layers.

4. The monolithic electro-photonic integrated circuit of claim 3, wherein:
the first set of epitaxial layers overlies the second set of epitaxial layers, or the second set of epitaxial layers overlies the first set of epitaxial layers.

5. The monolithic electro-photonic integrated circuit of claim 1, wherein
the optical waveguide of the EAM comprises a Quantum Confined Stark Effect (QCSE) EAM waveguide fabricated from a first set of epitaxial layers of the second plurality of semiconductor layers comprising a p-layer, a Multi-Quantum Well (MQW) i-region and an n-layer; and
the optical waveguide of the WG-PD is fabricated from a second set of epitaxial layers of the second plurality of semiconductor layers comprising a p-layer, an i-region comprising an absorption material, and an n-layer;
and a mode separating layer is provided between the first set of epitaxial layers and the second set of epitaxial layers.

6. The monolithic electro-photonic integrated circuit of claim 5, wherein:
the first set of epitaxial layers overlies the second set of epitaxial layers, or
the second set of epitaxial layers overlies the first set of epitaxial layers.

7. The monolithic electro-photonic integrated circuit of claim 1, wherein the spacer layer comprises a semi-insulating layer.

8. The monolithic electro-photonic integrated circuit of claim 1, wherein the spacer layer comprises at least one layer providing a mode separating layer and an electrical isolation layer
between the first plurality of semiconductor layers and the overlying second plurality of semiconductor layers.

9. The monolithic electro-photonic integrated circuit of claim 1, wherein the first plurality of semiconductor layers underlying the photonics components on the first device area is laterally electrically isolated from the first plurality of semiconductor layers providing the electronics components on the second device area by an electrical isolation region.

10. The monolithic electro-photonic integrated circuit of claim 1, wherein
the SI substrate has a first edge of length L1 and a second edge of length L2 extending perpendicular to the first edge, the first device area comprising the photonics components extends from the first edge and optical ports comprising an Rx-input port of the receiver and a Tx-output port of the transmitter are arranged along the first edge, and the second device area comprising the electronics components is positioned behind the first area, extending further from the first edge.

11. The monolithic electro-photonic integrated circuit of claim 1, comprising a laser input port on a first edge for coupling to an external laser, and an optical waveguide connecting the laser input port to an optical input port of the EAM.

12. The monolithic electro-photonic integrated circuit of claim 1, comprising a laser which is optically coupled to an input port of the EAM to form an electro-absorption modulated laser (EML), a laser waveguide of the laser comprising another set of epitaxial layers of the second plurality of semiconductors layers, wherein the electronics components comprise a laser driver circuit, and the at least one metallization layer provides interconnections between the laser driver circuit and the laser.

13. An electro-photonic module comprising a plurality monolithic integrated circuits as defined in claim 1, and a carrier substrate, the plurality monolithic integrated circuits being arranged with respect to a first edge of the carrier substrate to position optical ports comprising Rx-input ports of the WG-PDs and the Tx-output ports of the EAMs along the first edge.

14. The monolithic integrated circuit of claim 13, wherein the Rx-input ports are interleaved with the Tx-output ports along the first edge.

15. The monolithic electro-photonic integrated circuit of claim 1, arranged in one or more cells, wherein each cell comprises at least one of a combination of a receiver and a transmitter, a combination of more than one receiver or a combination of more than one transmitter.

16. The monolithic electro-photonic integrated circuit of claim 15, wherein the one or more cells each comprise a combination of a receiver and a transmitter, the one or more cells being arranged with respect to a first edge of the SI substrate to position optical ports comprising Rx-input ports of the WG-PDs and the Tx-output ports of the EAMs along a first edge.

17. The monolithic integrated circuit of claim 16, wherein the Rx-input ports and the Tx-output ports are interleaved the first edge.

18. The monolithic integrated circuit of claim 16, wherein a port-to-port spacing of the Rx-input ports and the Tx-output ports along the first edge is in a range of 200 μm to 350 μm.

19. The monolithic integrated circuit of claim 16, wherein a port-to-port spacing of the Rx-input ports and the Tx-output ports along the first edge is <200 μm.

20. The monolithic integrated circuit of claim 16, comprising a laser input port on the first edge for receiving an optical input of an external laser, and an optical waveguide comprising optical splitters connecting the laser input port to input ports of the plurality of the EAMs.

21. The monolithic integrated circuit of claim 16, comprising a plurality of laser input ports on the first edge, and an optical waveguide comprising a 1:N optical splitter connecting each laser input port to input ports of a corresponding plurality N of the EAMs.

22. The monolithic electro-photonic integrated circuit of claim 16, wherein each cell comprises a laser which is optically coupled to an input port of the EAM to form an electro-absorption modulated laser (EML), a laser waveguide of the laser comprising another set of epitaxial layers of the second plurality of semiconductors layers, and wherein the electronics components comprise a laser driver circuit, the at least one metallization layer providing an interconnection between the laser driver circuit and the laser.

23. The monolithic integrated circuit of claim 15, comprising at least one laser, an optical waveguide comprising a 1:N optical splitter connecting the at least one laser to respective input ports of a corresponding plurality N of the EAMs.

24. The monolithic electro-photonic integrated circuit of claim 15, further comprising a photonics area for the receivers and the transmitters that comprises a plurality of EAM areas and a plurality of WG-PD areas distributed over the device area, and an electronics area that comprises a plurality EAM driver circuit areas and a plurality of TIA areas which are distributed around the plurality of EAM areas and the plurality of WG-PD areas.

25. The monolithic electro-photonic integrated circuit of claim 24, wherein each EAM driver circuit area is adjacent a respective EAM area, and each TIA area is adjacent a respective WG-PD, so that electrical interconnections between each EAM driver circuit and EAM and between each WG-PD and TIA have lengths ≤20 μm.

26. A monolithic electro-photonic integrated circuit comprising a transmitter and a receiver fabricated on a semi-insulating (SI) substrate, wherein the transmitter comprises an electro-absorption modulator (EAM) and an EAM driver circuit and the receiver comprises a waveguide (WG)-photodiode (PD) and a transimpedance amplifier (TIA);
the SI substrate having a device area defined by a first edge of length L1 and a second edge of length L2, said device area comprising a photonics area and an electronics area;
photonics components comprising the EAM and the WG-PD occupying the photonics area;
electronics components comprising the EAM driver circuit and the TIA occupying the electronics area;
at least one metallization layer providing electrical connections between the EAM driver circuit and the EAM and between the WG-PD and the TIA; and
wherein optical ports comprising an optical input port of the WG-PD and an optical output port of the EAM are arranged along the first edge.

27. The monolithic electro-photonic integrated circuit of claim 26, comprising a plurality of transmitters and a plurality of receivers fabricated on the semi-insulating (SI) substrate, wherein optical ports comprise an optical input port of each WG-PD and an optical output port of each EAM are arranged along the first edge.

28. The monolithic electro-photonic integrated circuit of claim 1, fabricated with III-V semiconductor materials.

29. The monolithic electro-photonic integrated circuit of claim 1, fabricated with an InP based semiconductor material system.

30. The monolithic electro-photonic integrated circuit of claim 1, wherein the SI substrate is Fe-doped InP, fabricated from an InP-based material system, comprising selected binary, ternary and quaternary and other compositions of In, Ga, As, P, Al, and Sb.
